(19) United States
(12) Patent Application Publication
(10) Pub. No.: US 2026/0190165 A1
(43) Pub. Date: Jul. 2, 2026

(54) METHOD AND DEVICE FOR DIRECT COMMUNICATION IN WIRELESS LAN SUPPORTING EMLSR

(71) Applicant: ELECTRONICS AND TELECOMMUNICATIONS RESEARCH INSTITUTE, Daejeon (KR)

(72) Inventors: Sung Hyun HWANG, Daejeon (KR); Kyu Min KANG, Daejeon (KR); Yong Ho KIM, Incheon (KR); Ju Seong MOON, Osan-si, Gyeonggi-do (KR)

(21) Appl. No.: 19/130,072

(22) PCT Filed: Dec. 13, 2023
(86) PCT No.: PCT/KR2023/020570

§ 371 Date: May 14, 2025

(30) Foreign Application Priority Data
Dec. 14, 2022 (KR) 10-2022-0175253
May 4, 2023 (KR) 10-2023-0058649

(51) Int. Cl. H04W 76/14; H04W 8/00; H04W 8/22; H04W 74/0816; H04W 76/30

(52) U.S. Cl. CPC H04W 76/14; H04W 8/005; H04W 8/22; H04W 74/0816; H04W 76/30

(57) ABSTRACT

A method and a device for direct communication in a wireless LAN supporting EMLSR are disclosed. A method of a first STA comprises the steps of: performing a procedure of direct communication establishment with a second STA on a first link; performing, with an AP, a procedure of stopping an EMLSR operation of the first STA; and after the EMLSR operation is stopped, performing direct communication with the second STA on the first link.

### TECHNICAL FIELD

The present disclosure relates to a wireless local area network (LAN) communication technique, and more particularly, to a direct communication technique in a wireless LAN supporting enhanced multi-link single-radio (EMLSR).

### BACKGROUND ART

Recently, as the spread of mobile devices expands, a wireless local area network technology capable of providing fast wireless communication services to mobile devices is in the spotlight. The wireless LAN technology may be a technology that supports mobile devices such as smart phones, smart pads, laptop computers, portable multimedia players, embedded devices, and the like to wirelessly access the Internet based on wireless communication technology.

As applications requiring higher throughput and applications requiring real-time transmission occur, the IEEE 802.11be standard, which is an extreme high throughput (EHT) wireless LAN technology, is being developed. The goal of the IEEE 802.11be standard may be to support a high throughput of 30 Gbps. The IEEE 802.11be standard may support techniques for reducing a transmission latency. In addition, the IEEE 802.11be standard can support a more expanded frequency bandwidth (e.g., 320 MHz bandwidth), multi-link transmission and aggregation operations including multi-band operations, multi-access point (AP) transmission operations, and/or efficient retransmission operations (e.g., hybrid automatic repeat request (HARQ) operations).

However, since a multi-link operation is an operation not defined in the existing wireless LAN standard, it may be required to define detailed operations according to an environment in which the multi-link operation is performed. In particular, a device (e.g., station (STA), access point (AP), multi-link device (MLD)) supporting enhanced multi-link single radio (EMLSR) operations may wait for reception in a multi-link. The device supporting EMLSR operations may be referred to as an EMLSR device.

When an EMLSR device starts transmitting and receiving frame(s) on a single link, the EMLSR device may operate only on the single link. In other words, the EMLSR device cannot transmit/receive frame(s) in other links while performing frame transmission/reception on the single link. Interference may occur between multiple links. Transmissions on one link may cause interference on the other link(s). Due to the above-described constraints, additional detailed operations for EMLSR operations may be required.

Meanwhile, the technologies that are the background of the present disclosure are written to improve the understanding of the background of the present disclosure and may include content that is not already known to those of ordinary skill in the art to which the present disclosure belongs.

### DISCLOSURE

### Technical Problem

The present disclosure is directed to providing a method and an apparatus for direct communication in a wireless LAN supporting EMLSR.

### Technical Solution

A method of a first station (STA), according to exemplary embodiments of the present disclosure for achieving the above-described objective, may comprise: performing a procedure for configuring direct communication with a second STA on a first link; performing a procedure for stopping an enhanced multi-link single radio (EMLSR) operation of the first STA with an access point (AP); and after the EMLSR operation is stopped, performing direct communication with the second STA on the first link.

The performing of the procedure for configuring direct communication may comprise: receiving a tunneled direct link setup (TDLS) setup request frame of the second STA through the AP; in response to the TDLS setup request frame, transmitting a TDLS setup response frame to the second STA through the AP; and in response to the TDLS setup response frame, receiving a TDLS setup confirm frame of the second STA through the AP, wherein the TDLS setup response frame includes EMLSR capability information element(s) of the first STA, and the TDLS setup confirm frame indicates completion of TDLS setup.

The performing of the procedure for stopping the EMLS operation with the AP may comprise: transmitting, to the AP, a first enhanced multi-link (EML) operating mode notification (OMN) frame that the EMLSR operation is to be stopped; and in response to the first EML OMN frame, receiving a second EML OMN frame from the AP indicating that the EMLSR operation is stopped.

Each of the first EML OMN frame and the second EML OMN frame may include at least one of information indicating that the EMLSR operation is to be stopped or information on a link that the first STA is to use.

The method may further comprise: transmitting a TDLS teardown frame requesting to release configuration of the direct communication to the second STA or the AP, wherein when a transmission and reception procedure of the TDLS teardown frame is completed, the configuration of the direct communication may be released.

The method may further comprise: performing a discovery procedure for discovering direct communication configuration before performing the procedure for configuring the direct communication, wherein the performing of the discovery procedure may comprise: receiving a TDLS discovery request frame of the second STA through the AP; and in response to the TDLS discovery request frame, transmitting a TDLS discovery response frame to the second STA through the AP, wherein the TDLS discovery response frame may include EMLSR capability information element(s) of the first STA, and the procedure for configuring the direct communication may be performed between the first STA and the second STA discovered in the discovery procedure.

The method may further comprise: when the direct communication between the first STA and the second STA is completed, resuming the EMLSR operation of the first STA.

The first STA may be affiliated with a first STA multi-link device (MLD) operating on multiple links including the first link, and the second STA may be affiliated with a second STA MLD operating on the multiple links including the first link.

A method of a first station (STA), according to exemplary embodiments of the present disclosure for achieving the above-described objective, may comprise: performing a procedure for configuring direct communication with a second STA on a first link; performing a transmit opportunity (TXOP) sharing procedure with an access point (AP); and performing direct communication with the second STA within a TXOP shared by the TXOP sharing procedure.

The performing of the procedure for configuring direct communication may comprise: transmitting a tunneled direct link setup (TDLS) setup request frame to the second STA through the AP; in response to the TDLS setup request frame, receiving a TDLS setup response frame of the second STA through the AP; and in response to the TDLS setup response frame, transmitting a TDLS setup confirm frame to the second STA through the AP, wherein the TDLS setup response frame may include EMLSR capability information element(s) of the second STA, and the TDLS setup confirm frame may indicate completion of TDLS setup.

The performing of the TXOP sharing procedure may comprise: receiving a multi-user (MU)-request-to-send (RTS) frame indicating TXOP sharing from the AP; and transmitting a clear-to-send (CTS) frame to the AP in response to the MU-RTS frame.

The method may further comprise: transmitting a MU-RTS frame to the second STA in the shared TXOP; and receiving a CTS frame from the second STA in response to the MU-RTS frame, wherein the direct communication may be performed within a duration indicated by the MU-RTS frame in the shared TXOP.

The method may further comprise: transmitting a TDLS teardown frame requesting to release configuration of the direct communication to the second STA or the AP, wherein when a transmission and reception procedure of the TDLS teardown frame is completed, the configuration of the direct communication may be released.

The method may further comprise: performing a discovery procedure for discovering direct communication configuration before performing the procedure for configuring the direct communication, wherein the performing of the discovery procedure may comprise: transmitting a TDLS discovery request frame through the AP; and in response to the TDLS discovery request frame, receiving a TDLS discovery response frame of the second STA through the AP, wherein the TDLS discovery response frame may include EMLSR capability information element(s) of the second STA, and the procedure for configuring the direct communication may be performed between the first STA and the second STA discovered in the discovery procedure.

The first STA may be affiliated with a first STA multi-link device (MLD) operating on multiple links including the first link, and the second STA may be affiliated with a second STA MLD operating on the multiple links including the first link.

A first station (STA), according to exemplary embodiments of the present disclosure for achieving the above-described objective, may comprise: at least one processor, and the at least one processor may cause the first STA to perform: performing a procedure for configuring direct communication with a second STA on a first link; performing a procedure for stopping an enhanced multi-link single radio (EMLSR) operation of the first STA with an access point (AP); and after the EMLSR operation is stopped, performing direct communication with the second STA on the first link.

In the performing of the procedure for configuring direct communication, the at least one processor may further cause the first STA to perform: receiving a tunneled direct link setup (TDLS) setup request frame of the second STA through the AP; in response to the TDLS setup request frame, transmitting a TDLS setup response frame to the second STA through the AP; and in response to the TDLS setup response frame, receiving a TDLS setup confirm frame of the second STA through the AP, wherein the TDLS setup response frame may include EMLSR capability information element(s) of the first STA, and the TDLS setup confirm frame may indicate completion of TDLS setup.

In the performing of the procedure for stopping the EMLS operation with the AP, the at least one processor may further cause the first STA to perform: transmitting, to the AP, a first enhanced multi-link (EML) operating mode notification (OMN) frame that the EMLSR operation is to be stopped; and in response to the first EML OMN frame, receiving a second EML OMN frame from the AP indicating that the EMLSR operation is stopped.

The at least one processor may further cause the first STA to perform: transmitting a TDLS teardown frame requesting to release configuration of the direct communication to the second STA or the AP, wherein when a transmission and reception procedure of the TDLS teardown frame is completed, the configuration of the direct communication may be released.

The at least one processor may further cause the first STA to perform: when the direct communication between the first STA and the second STA is completed, resuming the EMLSR operation of the first STA.

### advantageous Effects

According to the present disclosure, a communication node (e.g., STA, AP, MLD) operating on a multi-link may configure direct communication with another communication node to perform the direct communication. The AP (e.g., AP MLD) can support direct communication configuration (e.g., direct communication configuration between STAs). Direct communication configuration information and/or frames for direct communication configuration may be transmitted and received through the AP (e.g., AP MLD). The direct communication can be configured on a link used for the direct communication among multiple links. In other words, the direct communication configuration can be applied to the link used for direct communication among multiple links.

Each of the STA MLD and AP MLD can support multi-link single-radio (MLSR) operation (e.g., enhanced MLSR (EMLSR) operation). The STA MLD supporting EMLSR operations may be an EMLSR STA MLD, and the AP MLD supporting EMLSR operations may be an EMLSR AP MLD. The STA MLD can change the EMLSR operation after or before configuring direct communication. The AP MLD can identify the direct communication configuration information and may not transmit a frame (e.g., initial control frame, other frames) for EMLSR operation to the STA MLD on a link for which direct communication is not configured. Accordingly, the direct communication of STA MLD can be protected, and direct communication of the STA MLD can be performed smoothly.

### DESCRIPTION OF DRAWINGS

FIG. 1 is a conceptual diagram illustrating a first exemplary embodiment of a wireless LAN system.

FIG. 2 is a block diagram illustrating a first exemplary embodiment of a communication node constituting a wireless LAN system.

FIG. 3 is a conceptual diagram illustrating a first exemplary embodiment of a multi-link configured between multi-link devices (MLDs).

FIG. 4 is a sequence chart illustrating a first exemplary embodiment of a negotiation procedure for a multi-link operation in a wireless LAN system.

FIG. 5 is a timing diagram illustrating a first exemplary embodiment of a direct communication method in a wireless LAN.

FIG. 6 is a timing diagram illustrating a second exemplary embodiment of a direct communication method in a wireless LAN.

FIG. 7 is a timing diagram illustrating a third exemplary embodiment of a direct communication method in a wireless LAN.

FIG. 8 is a timing diagram illustrating a fourth exemplary embodiment of a direct communication method in a wireless LAN.

FIG. 9 is a timing diagram illustrating a fifth exemplary embodiment of a direct communication method in a wireless LAN.

FIG. 10 is a timing diagram illustrating a sixth exemplary embodiment of a direct communication method in a wireless LAN.

FIG. 11 is a timing diagram illustrating a seventh exemplary embodiment of a direct communication method in a wireless LAN.

FIG. 12 is a timing diagram illustrating an eighth exemplary embodiment of a direct communication method in a wireless LAN.

FIG. 13A is a timing diagram illustrating a first exemplary embodiment of a method for discovering direct communication configuration in a wireless LAN.

FIG. 13B is a timing diagram illustrating a first exemplary embodiment of a method for configuring direct communication in a wireless LAN.

FIG. 13C is a timing diagram illustrating a first exemplary embodiment of a method for releasing direct communication configuration in a wireless LAN.

FIG. 14 is a timing diagram illustrating a ninth exemplary embodiment of a direct communication method in a wireless LAN.

FIG. 15 is a timing diagram illustrating a tenth exemplary embodiment of a direct communication method in a wireless LAN.

FIG. 16 is a timing diagram illustrating an eleventh exemplary embodiment of a direct communication method in a wireless LAN.

FIG. 17 is a timing diagram illustrating a twelfth exemplary embodiment of a direct communication method in a wireless LAN.

### MODE FOR INVENTION

Since the present disclosure may be variously modified and have several forms, specific exemplary embodiments will be shown in the accompanying drawings and be described in detail in the detailed description. It should be understood, however, that it is not intended to limit the present disclosure to the specific exemplary embodiments but, on the contrary, the present disclosure is to cover all modifications and alternatives falling within the spirit and scope of the present disclosure.

Relational terms such as first, second, and the like may be used for describing various elements, but the elements should not be limited by the terms. These terms are only used to distinguish one element from another. For example, a first component may be named a second component without departing from the scope of the present disclosure, and the second component may also be similarly named the first component. The term “and/or” means any one or a combination of a plurality of related and described items.

In exemplary embodiments of the present disclosure, “at least one of A and B” may refer to “at least one of A or B” or “at least one of combinations of one or more of A and B”. In addition, “one or more of A and B” may refer to “one or more of A or B” or “one or more of combinations of one or more of A and B”.

When it is mentioned that a certain component is “coupled with” or “connected with” another component, it should be understood that the certain component is directly “coupled with” or “connected with” to the other component or a further component may be disposed therebetween. In contrast, when it is mentioned that a certain component is “directly coupled with” or “directly connected with” another component, it will be understood that a further component is not disposed therebetween.

The terms used in the present disclosure are only used to describe specific exemplary embodiments, and are not intended to limit the present disclosure. The singular expression includes the plural expression unless the context clearly dictates otherwise. In the present disclosure, terms such as ‘comprise’ or ‘have’ are intended to designate that a feature, number, step, operation, component, part, or combination thereof described in the specification exists, but it should be understood that the terms do not preclude existence or addition of one or more features, numbers, steps, operations, components, parts, or combinations thereof.

Unless otherwise defined, all terms (including technical and scientific terms) used herein have the same meaning as commonly understood by one of ordinary skill in the art to which this disclosure belongs. Terms that are generally used and have been in dictionaries should be construed as having meanings matched with contextual meanings in the art. In this description, unless defined clearly, terms are not necessarily construed as having formal meanings.

Hereinafter, forms of the present disclosure will be described in detail with reference to the accompanying drawings. In describing the disclosure, to facilitate the entire understanding of the disclosure, like numbers refer to like elements throughout the description of the figures and the repetitive description thereof will be omitted.

In the following, a wireless communication system to which exemplary embodiments according to the present disclosure are applied will be described. The wireless communication system to which the exemplary embodiments according to the present disclosure are applied is not limited to the contents described below, and the exemplary embodiments according to the present disclosure can be applied to various wireless communication systems. A wireless communication system may be referred to as a ‘wireless communication network’. The names of frames proposed in the present disclosure may be generalized such as first frame, second frame, third frame, and the like. In the present disclosure, a transmission time may mean a start time of frame transmission and/or an end time of frame transmission, and a reception time may mean a start time of frame reception and/or an end time of frame reception. Time may be interpreted as a time point depending on a context.

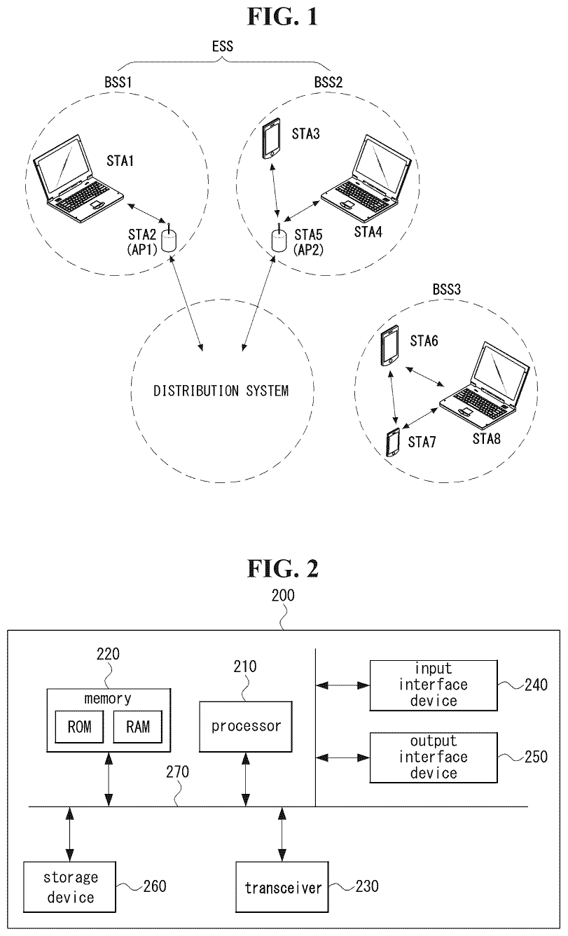

FIG. 1 is a conceptual diagram illustrating a first exemplary embodiment of a wireless LAN system.

Referring to FIG. 1, a wireless LAN system may include at least one basic service set (BSS). A BSS may refer to a set of stations (e.g., STA1, STA2 (AP1), STA3, STA4, STA5 (AP2), STA6, STA7, and STA8) that can communicate with each other through successful synchronization, and may not refer to a specific region. In exemplary embodiments below, a station performing functions as an access point may be referred to as an ‘access point (AP)’, and a station not performing functions as an access point may be referred to as a ‘non-AP station’ or a ‘station’.

The BSS may be classified into an infrastructure BSS and an independent BSS (IBSS). Here, a BSS1 and a BSS2 may mean infrastructure BSSs, and a BSS3 may mean an IBSS. The BSS1 may include a first station (STA1), a first access point (STA2 (AP1)) providing a distribution service, and a distribution system (DS) connecting a plurality of access points (STA2 (AP1) and STA5 (AP2)). In the BSS1, the first access point STA2 (AP1) may manage the first station STA1.

The BSS2 may include a third station (STA3), a fourth station (STA4), a second access point (STA5 (AP2)) providing a distribution service, and a DS connecting the plurality of access points (STA2 (AP1) and STA5 (AP2)). In the BSS2, the second access point STA5 (AP2) may manage the third station STA3 and the fourth station STA4.

The BSS3 may mean an IBSS operating in an ad-hoc mode. An access point, which is a centralized management entity, may not exist in the BSS3. That is, in the BSS3, the stations STA6, STA7, and STA8 may be managed in a distributed manner. In the BSS3, all stations STA6, STA7, and STA8 may refer to mobile stations, and since they are not allowed to access a DS, they may constitute a self-contained network.

The access points STA2 (AP1) and STA5 (AP2) may provide access to the DS for the stations STA1, STA3, and STA4 associated therewith via a wireless medium. In the BSS1 or BSS2, communications between the stations STA1, STA3, and STA4 are generally performed through the access points STA2 (AP1) and STA5 (AP2), but when direct links are established, direct communications between the stations STA1, STA3, and STA4 may be possible.

A plurality of infrastructure BSSs may be interconnected through a DS. The plurality of BSSs connected through the DS may be referred to as an extended service set (ESS). The communication nodes STA1, STA2 (AP1), STA3, STA4, and STA5 (AP2) included in the ESS may communicate with each other, and an arbitrary station (STA1, STA3, or STA4) may move from one BSS to another BSS within the same ESS while communicating without interruption.

The DS may be a mechanism for one access point to communicate with another access point, according to which an access point may transmit frames for stations associated with the BSS it manages, or transmit frames for an arbitrary station that has moved to another BSS. Also, the access point may transmit and receive frames to and from an external network such as a wired network. Such the DS may not necessarily have to be a network, and if it can provide a predetermined distribution service stipulated in the IEEE 802.11 standard, there is no restriction on its form. For example, the DS may be a wireless network such as a mesh network or a physical structure that connects the access points to each other. The communication nodes STA1, STA2 (AP1), STA3, STA4, STA5 (AP2), STA6, STA7, and STA8 included in the wireless LAN system may be configured as follows.

FIG. 2 is a block diagram illustrating a first exemplary embodiment of a communication node constituting a wireless LAN system.

Referring to FIG. 2, a communication node 200 may be an AP, STA, AP MLD, STA MLD, EMLSR AP MLD, or EMLSR STA MLD. The STA may be a non-AP STA. An operating channel width supported by the AP may be 20 megahertz (MHz), 80 MHz, 160 MHz, or the like. An operating channel width supported by the STA may be 20 MHz, 80 MHz, or the like. In the present disclosure, an AP may be interpreted as an AP MLD or EMLSR AP MLD depending on a context, a STA may be interpreted as a STA MLD or EMLSR STA MLD depending on a context, and a MLD may be interpreted as an AP MLD, STA MLD, or EMLSR AP MLD, or EMLSR STA MLD depending on a context. The EMLSR operation may include a MLSR operation. An EMLSR may be interpreted as a MLSR depending on a context, and a MLSR may be interpreted as an EMLSR depending on a context. Operations of an AP MLD may be interpreted as operations of an AP affiliated with the AP MLD, and operations of an AP may be interpreted as operations of an AP MLD affiliated with the AP. Operations of a STA MLD may be interpreted as operations of a STA affiliated with the STA MLD, and operations of a STA may be interpreted as operations of a STA MLD affiliated with the STA.

The communication node 200 may include at least one processor 210, a memory 220, and a transceiver 230 connected to a network to perform communications. The transceiver 230 may be referred to as a transceiver, a radio frequency (RF) unit, an RF module, or the like. In addition, the communication node 200 may further include an input interface device 240, an output interface device 250, a storage device 260, and the like. The respective components included in the communication node 200 may be connected by a bus 270 to communicate with each other.

However, the respective components included in the communication node 200 may be connected through individual interfaces or individual buses centering on the processor 210 instead of the common bus 270. For example, the processor 210 may be connected to at least one of the memory 220, the transceiver 230, the input interface device 240, the output interface device 250, and the storage device 260 through a dedicated interface.

The processor 210 may execute program commands stored in at least one of the memory 220 and the storage device 260. The processor 210 may refer to a central processing unit (CPU), a graphics processing unit (GPU), or a dedicated processor on which the methods according to the exemplary embodiments of the present invention are performed. Each of the memory 220 and the storage device 260 may be configured as at least one of a volatile storage medium and a nonvolatile storage medium. For example, the memory 220 may be configured with at least one of a read only memory (ROM) and a random access memory (RAM).

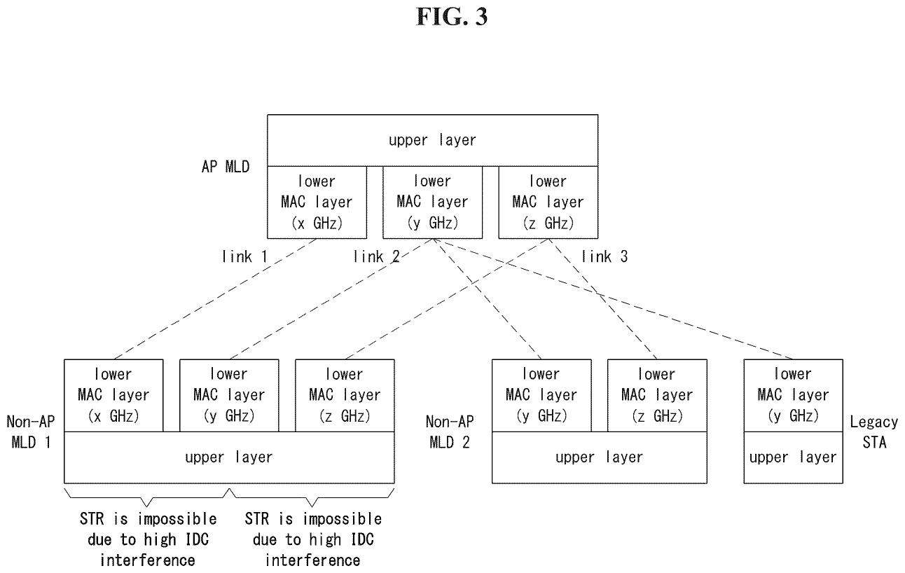

FIG. 3 is a conceptual diagram illustrating a first exemplary embodiment of a multi-link configured between multi-link devices (MLDs).

Referring to FIG. 3, an MLD may have one medium access control (MAC) address. In exemplary embodiments, the MLD may mean an AP MLD and/or non-AP MLD. The MAC address of the MLD may be used in a multi-link setup procedure between the non-AP MLD and the AP MLD. The MAC address of the AP MLD may be different from the MAC address of the non-AP MLD. AP(s) affiliated with the AP MLD may have different MAC addresses, and station(s) affiliated with the non-AP MLD may have different MAC addresses. Each of the APs having different MAC addresses within the AP MLD may be in charge of each link, and may perform a role of an independent AP.

Each of the STAs having different MAC addresses within the non-AP MLD may be in charge of each link, and may perform a role of an independent STA. The non-AP MLD may be referred to as a STA MLD. The MLD may support a simultaneous transmit and receive (STR) operation. In this case, the MLD may perform a transmission operation in a link 1 and may perform a reception operation in a link 2. The MLD supporting the STR operation may be referred to as an STR MLD (e.g., STR AP MLD, STR non-AP MLD). In exemplary embodiments, a link may mean a channel or a band. A device that does not support the STR operation may be referred to as a non-STR (NSTR) AP MLD or an NSTR non-AP MLD (or NSTR STA MLD). The AP of the AP MLD may mean an AP affiliated with the AP MLD. The STA of the STA MLD may mean a STA affiliated with the STA MLD.

The MLD may transmit and receive frames in multiple links by using a non-contiguous bandwidth extension scheme (e.g., 80 MHz+80 MHz). The multi-link operation may include multi-band transmission. The AP MLD may include a plurality of APs, and the plurality of APs may operate in different links. Each of the plurality of APs may perform function(s) of a lower MAC layer. Each of the plurality of APs may be referred to as a ‘communication node’ or ‘lower entity’. The communication node (i.e., AP) may operate under control of an upper layer (or the processor 210 shown in FIG. 2). The non-AP MLD may include a plurality of STAs, and the plurality of STAs may operate in different links. Each of the plurality of STAs may be referred to as a ‘communication node’ or ‘lower entity’. The communication node (i.e., STA) may operate under control of an upper layer (or the processor 210 shown in FIG. 2).

The MLD may perform communications in multiple bands (i.e., multi-band). For example, the MLD may perform communications using an 80 MHz bandwidth according to a channel expansion scheme (e.g., bandwidth expansion scheme) in a 2.4 GHz band, and perform communications using a 160 MHz bandwidth according to a channel expansion scheme in a 5 GHz band. The MLD may perform communications using a 160 MHz bandwidth in the 5 GHz band, and may perform communications using a 160 MHz bandwidth in a 6 GHz band. One frequency band (e.g., one channel) used by the MLD may be defined as one link. Alternatively, a plurality of links may be configured in one frequency band used by the MLD. For example, the MLD may configure one link in the 2.4 GHz band and two links in the 6 GHz band. The respective links may be referred to as a first link, a second link, and a third link. Alternatively, each link may be referred to as a link 1, a link 2, a link 3, or the like. A link number may be set by an access point, and an identifier (ID) may be assigned to each link.

The MLD (e.g., AP MLD and/or non-AP MLD) may configure a multi-link by performing an access procedure and/or a negotiation procedure for a multi-link operation. In this case, the number of links and/or link(s) to be used in the multi-link may be configured. The non-AP MLD (e.g., STA) may identify information on band(s) capable of communicating with the AP MLD. In the negotiation procedure for a multi-link operation between the non-AP MLD and the AP MLD, the non-AP MLD may configure one or more links among links supported by the AP MLD to be used for the multi-link operation. A station that does not support a multi-link operation (e.g., IEEE 802.11a/b/g/n/ac/ax STA) may be connected to one or more links of the multi-link supported by the AP MLD.

When a band separation between multiple links (e.g., a band separation between a link 1 and a link 2 in the frequency domain) is sufficient, the MLD may be able to perform an STR operation. For example, the MLD may transmit a physical layer convergence procedure (PLCP) protocol data unit (PPDU) 1 using the link 1 among multiple links, and may receive a PPDU 2 using the link 2 among multiple links. On the other hand, if the MLD performs an STR operation when the band separation between multiple links is not sufficient, in-device coexistence (IDC) interference, which is interference between the multiple links, may occur. Accordingly, when the bandwidth separation between multiple links is not sufficient, the MLD may not be able to perform an STR operation.

For example, a multi-link including a link 1, a link 2, and a link 3 may be configured between an AP MLD and a non-AP MLD 1. When a band separation between the link 1 and the link 3 is sufficient, the AP MLD may perform an STR operation using the link 1 and the link 3. That is, the AP MLD may transmit a frame using the link 1 and receive a frame using the link 3. When a band separation between the link 1 and the link 2 is insufficient, the AP MLD may not be able to perform an STR operation using the link 1 and the link 2. When a band separation between the link 2 and the link 3 is not sufficient, the AP MLD may not be able to perform an STR operation using the link 2 and the link 3.

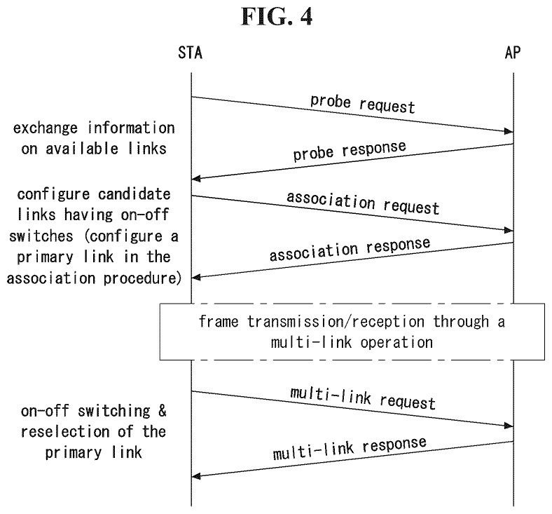

FIG. 4 is a sequence chart illustrating a first exemplary embodiment of a negotiation procedure for a multi-link operation in a wireless LAN system.

Referring to FIG. 4, an access procedure between an STA and an AP in an infrastructure basic service set (BSS) may generally be divided into a probe step of probing AP(s), an authentication step for authentication between the STA and the probed AP, and an association step of association between the STA and the authenticated AP.

In the probe step, the STA may detect one or more APs using a passive scanning scheme or an active scanning scheme. When the passive scanning scheme is used, the STA may detect one or more APs by overhearing beacons transmitted by the one or more APs. When the active scanning scheme is used, the STA may transmit a probe request frame, and may detect one or more APs by receiving probe response frames that are responses to the probe request frame from the one or more APs.

When the one or more APs are detected, the STA may perform an authentication step with the detected AP(s). In this case, the STA may perform the authentication step with a plurality of APs. An authentication algorithm according to the IEEE 802.11 standard may be classified into an open system algorithm of exchanging two authentication frames, a shared key algorithm of exchanging four authentication frames, and the like.

The STA may transmit an authentication request frame based on the authentication algorithm according to the IEEE 802.11 standard, and may complete authentication with the AP by receiving an authentication response frame that is a response to the authentication request frame from the AP.

When the authentication with the AP is completed, the STA may perform an association step with the AP. In particular, the STA may select one AP among AP(s) with which the STA has performed the authentication step, and perform the association step with the selected AP. That is, the STA may transmit an association request frame to the selected AP, and may complete the association with the AP by receiving an association response frame that is a response to the association request frame from the selected AP.

Meanwhile, a multi-link operation may be supported in the wireless LAN system. A multi-link device (MLD) may include one or more STAs affiliated with the MLD. The MLD may be a logical entity. The MLD may be classified into an AP MLD and a non-AP MLD. Each STA affiliated with the AP MLD may be an AP, and each STA affiliated with the non-AP MLD may be a non-AP STA. In order to configure a multi-link, a multi-link discovery procedure, a multi-link setup procedure, and the like may be performed. The multi-link discovery procedure may be performed in the probe step between an STA and an AP. In this case, multi-link information elements (ML IEs) may be included in the beacon frame, the probe request frame, and/or the probe response frame.

For example, in order to perform a multi-link operation, in the probe step, the AP (e.g., AP affiliated with an MLD) may exchange information indicating whether the multi-link operation can be used and information on available link(s) with the STA (e.g., non-AP STA affiliated with an MLD). In a negotiation procedure for the multi-link operation (e.g., multi-link setup procedure), the STA may transmit information of link(s) to be used for the multi-link operation. The negotiation procedure for the multi-link operation may be performed in the access procedure (e.g., association step) between the STA and the AP, and information element(s) required for the multi-link operation may be configured or changed by an action frame in the negotiation procedure.

In addition, in the access procedure (e.g., association step) between the STA and the AP, available link(s) of the AP may be configured, and an identifier (ID) may be assigned to each link. Thereafter, in the negotiation procedure and/or change procedure for the multi-link operation, information indicating whether each link is activated may be transmitted, and the information may be expressed using the link ID(s).

The information indicating whether the multi-link operation can be used may be transmitted and received in a procedure of exchanging capability information element(s) (e.g., EHT capability information element(s)) between the STA and the AP. The capability information element(s) may include information of supporting band(s), information of supporting link(s) (e.g., ID(s) and/or number of supporting link(s)), information of links capable of simultaneous transmission and reception (STR) operations (e.g., information on bands of the links, information on a separation between the links), and/or the like. In addition, the capability information element(s) may include information that individually indicates a link capable of the STR operation.

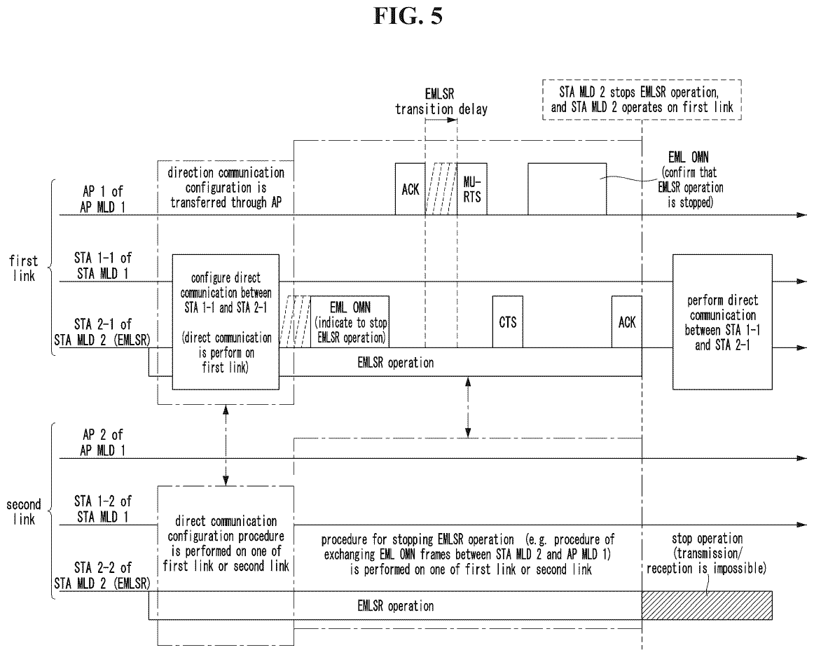

FIG. 5 is a timing diagram illustrating a first exemplary embodiment of a direct communication method in a wireless LAN.

Referring to FIG. 5, the wireless LAN may support multi-link operations. An AP MLD 1, STA MLD 1, and/or STA MLD 2 may operate on a multi-link (e.g., first link and second link). An AP affiliated with the AP MLD 1 operating on the first link may be referred to as an AP 1 (or AP 1-1). An AP affiliated with the AP MLD 1 operating on the second link may be referred to as an AP 2 (or AP 1-2). A STA affiliated with the STA MLD 1 operating on the first link may be referred to as a STA 1-1. A STA affiliated with the STA MLD 1 operating on the second link may be referred to as a STA 1-2. A STA affiliated with the STA MLD 2 operating on the first link may be referred to as a STA 2-1. A STA affiliated with the STA MLD 2 operating on the second link may be referred to as a STA 2-2. The STA MLD 2 may support enhanced a multi-link single-radio (EMLSR) operation (e.g., MLSR operation). In other words, the STA MLD 2 may be an EMLSR STA MLD (e.g., MLSR STA MLD).

The STA MLD 2 may perform the EMLSR operation on the first link and the second link. A procedure for configuring direct communication between the STA 1-1 (or another STA) and the STA 2-1 may be performed on the first link. In other words, a direct communication configuration may be set up on the first link. The direct communication configuration may be referred to as peer-to-peer (P2P) configuration or device-to-device (D2D) configuration. The direct communication configuration may be tunneled direct link setup (TDLS) configuration. A frame including information element(s) (e.g., parameter(s), field(s)) or indicator(s) for direct communication configuration may be transmitted and received through the AP. In other words, the AP may relay transmission of the frame including information element(s) (e.g., parameter(s), field(s)) or indicator(s) for direct communication configuration between STAs.

When direct communication (e.g., direct communication configuration) is configured on the first link, the STA MLD 2 may stop the EMLSR operation. For example, the STA MLD 2 may transmit an enhanced multi-link (EML) operating mode notification (OMN) frame to the AP MLD 1 through one of the first link or the second link. The EML OMN frame of the STA MLD 2 may be used to indicate that the EMLSR operation is to be stopped. The EML OMN frame may include at least one of EMLSR stop information or use link information. The EMLSR stop information may indicate that the EMLSR operation is to be stopped. For example, when an EMLSR mode of an EML control field included in the EML OMN frame is set to 0, it may be interpreted as the EMLSR stop information. As another example, when all links indicated by an EMLSR/EMLMR link bitmap of the EML control field included in the EML OMN frame are set to 0, it may be interpreted as the EMLSR stop information. As another example, both examples described above may be used. The use link information may indicate links that the communication node (e.g., STA MLD 2) transmitting the EML OMN frame is to use. The use link information may indicate the first link on which direct communication configuration is performed. The use link information may be transmitted through an exchange procedure of frame(s) other than the EML OMN frame.

The AP MLD 1 may receive the EML OMN frame from the STA MLD 2 and identify information element(s) or indicator(s) included in the EML OMN frame. The AP MLD 1 may identify that the EMLSR operation of the STA MLD 2 is to be stopped based on the information element(s) or indicator(s) included in the EML OMN frame. In addition, the AP MLD 1 may identify the link that the STA MLD 2 is to use based on the information element(s) or indicator(s) included in the EML OMN frame. The AP MLD 1 may transmit a response frame (e.g., acknowledgment (ACK) frame or block ACK (BA) frame) for the EML OMN frame to the STA MLD 2. In the present disclosure, the response frame may mean an ACK frame or BA frame. The STA MLD 2 may receive the response frame for the EML OMN frame from the AP MLD 1.

After an EMLSR transition delay elapses from a transmission time of the response frame for the EML OMN frame, the AP MLD 1 may perform a backoff operation. Alternatively, the backoff operation of the AP MLD 1 may start within a time corresponding to the EMLSR transition delay. When the backoff operation succeeds (e.g., the EMLSR transition delay elapses and the backoff operation succeeds), the AP MLD 1 may transmit a multi-user (MU)-request-to-send (RTS) frame to the STA MLD 2 on the first link. The STA MLD 2 may receive the MU-RTS frame from the AP MLD 1 and may transmit a clear-to-send (CTS) frame to the AP MLD 1 on the first link in response to the MU-RTS frame. In addition, the AP MLD 1 may transmit an EML OMN frame to the STA MLD 2 on the first link. Information element(s) or indicator(s) included in the EML OMN frame of the AP MLD 1 may be the same as the information element(s) or indicator(s) included in the EML OMN frame of the STA MLD 2. The EML OMN frame of the AP MLD 1 may indicate that the AP MLD 1 identifies that the EMLSR operation is to be stopped. The STA MLD 2 may receive the EML OMN frame from the AP MLD 1 and identify the information element(s) or indicator(s) included in the EML OMN frame. The STA MLD 2 may transmit a response frame (e.g., ACK frame) for the EML OMN frame of the AP MLD 1 to the AP MLD 1.

After transmission of the response frame for the EML OMN frame of the AP MLD 1, the STA MLD 2 may stop the EMLSR operation. As another method, the EMLSR operation may be stopped after a transition timeout elapses from a transmission time of the EMLSR operation stop information of the STA MLD 1. The transition timeout may be information exchangeable in a configuration procedure of the AP MLD 1 and the STA MLD 1. After the EMLSR operation is stopped, the STA MLD 2 may operate on the first link with direct communication configured. For example, the STA 2-1 may perform direct communication (e.g., P2P communication, D2D communication) with the STA 1-1 on the first link. When the direct communication between the STA 1-1 and the STA 2-1 is completed (e.g., teardown or stop), the STA MLD 2 and the AP MLD 1 may exchange an EML OMN frame to resume the EMLSR operation (e.g., an EMLSR mode of an EML control field of the EML OMN frame is set to 1, or it may be a frame including an EMLSR/EMLMR link bitmap indicating links to be used in the EMLSR operation). When the EMLSR operation is resumed, the STA MLD 2 may perform the EMLSR operation on the first link and/or the second link. In other words, the STA MLD 2 may not perform the EMLSR operation while direct communication is performed, and the STA MLD 2 may resume the EMLSR operation after the direct communication is completed.

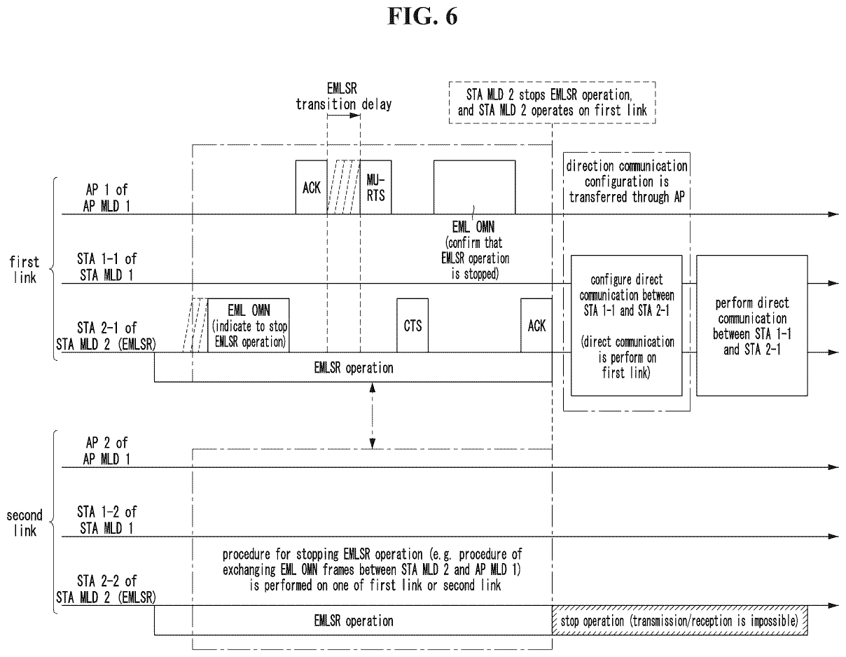

FIG. 6 is a timing diagram illustrating a second exemplary embodiment of a direct communication method in a wireless LAN.

Referring to FIG. 6, the wireless LAN may support multi-link operations. An AP MLD 1, STA MLD 1, and/or STA MLD 2 may operate on a multi-link (e.g., first link and second link). An AP affiliated with the AP MLD 1 operating on the first link may be referred to as an AP 1 (or AP 1-1). An AP affiliated with the AP MLD 1 operating on the second link may be referred to as an AP 2 (or AP 1-2). A STA affiliated with the STA MLD 1 operating on the first link may be referred to as a STA 1-1. A STA affiliated with the STA MLD 1 operating on the second link may be referred to as a STA 1-2. A STA affiliated with the STA MLD 2 operating on the first link may be referred to as a STA 2-1. A STA affiliated with the STA MLD 2 operating on the second link may be referred to as a STA 2-2. The STA MLD 2 may support enhanced an EMLSR operation (e.g., MLSR operation). In other words, the STA MLD 2 may be an EMLSR STA MLD (e.g., MLSR STA MLD).

The STA MLD 2 may perform the EMLSR operation on the first link and the second link. A procedure for configuring direct communication between the STA 1-1 (or another STA) and the STA 2-1 may be performed on the first link. In other words, a direct communication configuration may be set up on the first link. The direct communication configuration may be referred to as P2P configuration or D2D configuration. The direct communication configuration may be TDLS configuration. A frame including information element(s) (e.g., parameter(s), field(s)) or indicator(s) for direct communication configuration may be transmitted and received through the AP. In other words, the AP may relay transmission of the frame including information element(s) (e.g., parameter(s), field(s)) or indicator(s) for direct communication configuration between STAs.

The STA MLD 2 may stop the EMLSR operation before the STA MLD 2 (e.g., STA 2-1) performs the direct communication configuration procedure on the first link. For example, the STA MLD 2 may transmit an EML OMN frame to the AP MLD 1 through one of the first link or the second link. The EML OMN frame of the STA MLD 2 may be used to indicate that the EMLSR operation is to be stopped. The EML OMN frame may include at least one of EMLSR stop information or use link information. The EMLSR stop information may indicate that the EMLSR operation is to be stopped. For example, when an EMLSR mode of an EML control field included in the EML OMN frame is set to 0, it may be interpreted as the EMLSR stop information. As another example, when all links indicated by an EMLSR/EMLMR link bitmap of the EML control field included in the EML OMN frame are set to 0, it may be interpreted as the EMLSR stop information. As another example, both examples described above may be used. The use link information may indicate links that the communication node (e.g., STA MLD 2) transmitting the EML OMN frame is to use. The use link information may indicate the first link on which direct communication configuration is performed. The use link information may be transmitted through an exchange procedure of frame(s) other than the EML OMN frame.

The AP MLD 1 may receive the EML OMN frame from the STA MLD 2 and identify information element(s) or indicator(s) included in the EML OMN frame. The AP MLD 1 may identify that the EMLSR operation of the STA MLD 2 is to be stopped based on the information element(s) or indicator(s) included in the EML OMN frame. In addition, the AP MLD 1 may identify the link that the STA MLD 2 is to use based on the information element(s) or indicator(s) included in the EML OMN frame. The AP MLD 1 may transmit a response frame (e.g., ACK frame or BA frame) for the EML OMN frame to the STA MLD 2. The STA MLD 2 may receive the response frame for the EML OMN frame from the AP MLD 1.

After an EMLSR transition delay elapses from a transmission time of the response frame for the EML OMN frame, the AP MLD 1 may perform a backoff operation. Alternatively, the backoff operation of the AP MLD 1 may start within a time corresponding to the EMLSR transition delay. When the backoff operation succeeds (e.g., the EMLSR transition delay elapses and the backoff operation succeeds), the AP MLD 1 may transmit a MU-RTS frame to the STA MLD 2 on the first link. The STA MLD 2 may receive the MU-RTS frame from the AP MLD 1 and may transmit a CTS frame to the AP MLD 1 on the first link in response to the MU-RTS frame. In addition, the AP MLD 1 may transmit an EML OMN frame to the STA MLD 2 on the first link. Information element(s) or indicator(s) included in the EML OMN frame of the AP MLD 1 may be the same as the information element(s) or indicator(s) included in the EML OMN frame of the STA MLD 2. The EML OMN frame of the AP MLD 1 may indicate that the AP MLD 1 identifies that the EMLSR operation is to be stopped. The STA MLD 2 may receive the EML OMN frame from the AP MLD 1 and identify the information element(s) or indicator(s) included in the EML OMN frame. The STA MLD 2 may transmit a response frame (e.g., ACK frame) for the EML OMN frame of the AP MLD 1 to the AP MLD 1.

After transmission of the response frame to the EML OMN frame of the AP MLD 1, the STA MLD 2 may stop the EMLSR operation. After stopping the EMLSR operation, the STA MLD 2 may operate on the link on which direct communication is configured (e.g., first link). After the EMLSR operation of the STA MLD 2 is stopped, the STA 2-1 affiliated with the STA MLD 2 may perform a direct communication configuration procedure with the STA-1-1. A direct communication configuration may be made on the first link. The STA 2-1 may perform direct communication (e.g., P2P communication, D2D communication) with the STA 1-1 on the first link. When the direct communication between the STA 1-1 and the STA 2-1 is completed (e.g., teardown or stop), the STA MLD 2 and the AP MLD 1 may exchange an EML OMN frame indicating to resume the EMLSR operation (e.g., an EMLSR mode of an EML control field of the EML OMN frame is set to 1, or it may be a frame including an EMLSR/EMLMR link bitmap indicating links to be used in the EMLSR operation). When the EMLSR operation is resumed, the STA MLD 2 may perform the EMLSR operation on the first link and/or the second link. In other words, the STA MLD 2 may not perform the EMLSR operation while direct communication is performed, and the STA MLD 2 may resume the EMLSR operation after the direct communication is completed.

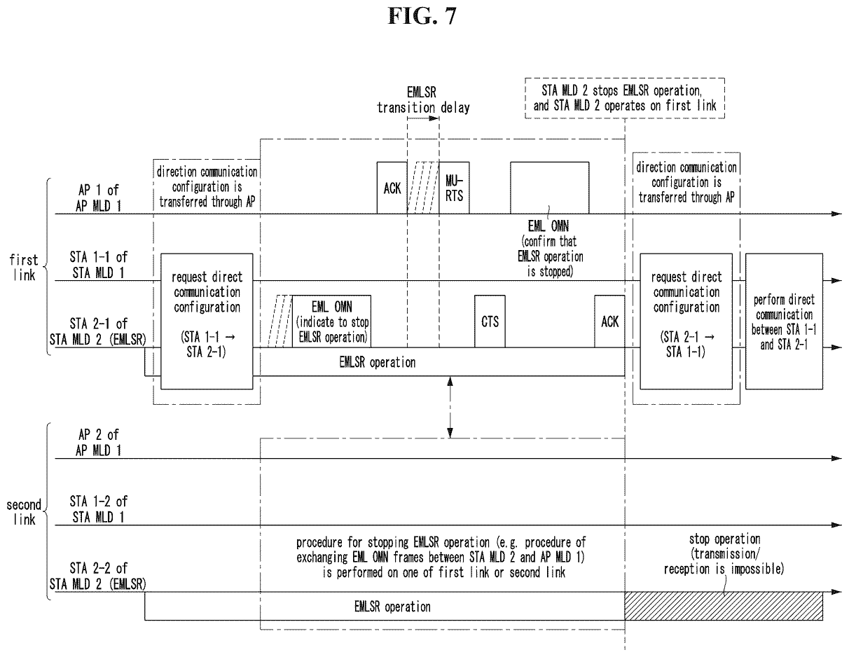

FIG. 7 is a timing diagram illustrating a third exemplary embodiment of a direct communication method in a wireless LAN.

Referring to FIG. 7, the wireless LAN may support multi-link operations. An AP MLD 1, STA MLD 1, and/or STA MLD 2 may operate on a multi-link (e.g., first link and second link). An AP affiliated with the AP MLD 1 operating on the first link may be referred to as an AP 1 (or AP 1-1). An AP affiliated with the AP MLD 1 operating on the second link may be referred to as an AP 2 (or AP 1-2). A STA affiliated with the STA MLD 1 operating on the first link may be referred to as a STA 1-1. A STA affiliated with the STA MLD 1 operating on the second link may be referred to as a STA 1-2. A STA affiliated with the STA MLD 2 operating on the first link may be referred to as a STA 2-1. A STA affiliated with the STA MLD 2 operating on the second link may be referred to as a STA 2-2. The STA MLD 2 may support enhanced an EMLSR operation (e.g., MLSR operation). In other words, the STA MLD 2 may be an EMLSR STA MLD (e.g., MLSR STA MLD).

The STA MLD 2 may perform the EMLSR operation on the first link and the second link. A procedure for configuring direct communication between the STA 1-1 (or another STA) and the STA 2-1 may be performed on the first link. In other words, a direct communication configuration may be set up on the first link. The direct communication configuration may be referred to as P2P configuration or D2D configuration. The direct communication configuration may be TDLS configuration. A frame including information element(s) (e.g., parameter(s), field(s)) or indicator(s) for direct communication configuration may be transmitted and received through the AP. In other words, the AP may relay transmission of the frame including information element(s) (e.g., parameter(s), field(s)) or indicator(s) for direct communication configuration between STAs.

The STA 1-1 may transmit a request frame for direct communication configuration to the STA 2-1 on the first link. The request frame for direct communication configuration may be delivered to the STA 2-1 through the AP 1. The STA 2-1 may receive the request frame for direct communication configuration of the STA 1-1. When the request frame for direct communication configuration of the STA 1-1 is received, the STA MLD 2 may stop the EMLSR operation. As another method, the EMLSR operation may be stopped after a transition timeout elapses from a transmission time of EMLSR operation stop information of STA MLD 1. The transition timeout may be information exchangeable in a configuration procedure of the AP MLD 1 and STA MLD 1. For example, the STA MLD 2 may transmit an EML OMN frame to the AP MLD 1 through one of the first link or the second link. The EML OMN frame of the STA MLD 2 may be used to indicate that the EMLSR operation is to be stopped. The EML OMN frame may include at least one of EMLSR stop information or use link information. The EMLSR stop information may indicate that the EMLSR operation is to be stopped. For example, when an EMLSR mode of an EML control field included in the EML OMN frame is set to 0, it may be interpreted as the EMLSR stop information. As another example, when all links indicated by an EMLSR/EMLMR link bitmap of the EML control field included in the EML OMN frame are set to 0, it may be interpreted as the EMLSR stop information. As another example, both examples described above may be used. The use link information may indicate links that the communication node (e.g., STA MLD 2) transmitting the EML OMN frame is to use. The use link information may indicate the first link on which direct communication configuration is performed. The use link information may be transmitted through an exchange procedure of frame(s) other than the EML OMN frame.

The AP MLD 1 may receive the EML OMN frame from the STA MLD 2 and identify information element(s) or indicator(s) included in the EML OMN frame. The AP MLD 1 may identify that the EMLSR operation of the STA MLD 2 is to be stopped based on the information element(s) or indicator(s) included in the EML OMN frame. In addition, the AP MLD 1 may identify the link that the STA MLD 2 is to use based on the information element(s) or indicator(s) included in the EML OMN frame. The AP MLD 1 may transmit a response frame (e.g., ACK frame or BA frame) for the EML OMN frame to the STA MLD 2. The STA MLD 2 may receive the response frame for the EML OMN frame from the AP MLD 1.

After an EMLSR transition delay elapses from a transmission time of the response frame for the EML OMN frame, the AP MLD 1 may perform a backoff operation. Alternatively, the backoff operation of the AP MLD 1 may start within a time corresponding to the EMLSR transition delay. When the backoff operation succeeds (e.g., the EMLSR transition delay elapses and the backoff operation succeeds), the AP MLD 1 may transmit a MU-RTS frame to the STA MLD 2 on the first link. The STA MLD 2 may receive the MU-RTS frame from the AP MLD 1 and may transmit a CTS frame to the AP MLD 1 on the first link in response to the MU-RTS frame. In addition, the AP MLD 1 may transmit an EML OMN frame to the STA MLD 2 on the first link. Information element(s) or indicator(s) included in the EML OMN frame of the AP MLD 1 may be the same as the information element(s) or indicator(s) included in the EML OMN frame of the STA MLD 2. The EML OMN frame of the AP MLD 1 may indicate that the AP MLD 1 identifies that the EMLSR operation is to be stopped. The STA MLD 2 may receive the EML OMN frame from the AP MLD 1 and identify the information element(s) or indicator(s) included in the EML OMN frame. The STA MLD 2 may transmit a response frame (e.g., ACK frame) for the EML OMN frame of the AP MLD 1 to the AP MLD 1.

After transmission of the response frame for the EML OMN frame of the AP MLD 1, the STA MLD 2 may stop the EMLSR operation. As another method, the EMLSR operation may be stopped after a transition timeout elapses from a transmission time of the EMLSR operation stop information of the STA MLD 1. The transition timeout may be information exchangeable in a configuration procedure of the AP MLD 1 and the STA MLD 1. After the EMLSR operation is stopped, the STA MLD 2 may operate on the first link with direct communication configured. In other words, the STA MLD 2 may operate on the first link where the request frame for direct communication configuration is received. The STA 2-1 may transmit a response frame for direct communication configuration to the STA 1-1 in response to the request frame for direct communication configuration. The response frame for direct communication configuration may be delivered from the STA 2-1 to the STA 1-1 through the AP 1. The STA 1-1 may receive the response frame for direct communication configuration of the STA 2-1.

When the exchange procedure of the request frame and response frame of direct communication configuration (e.g., direct communication configuration procedure) is completed, the STA 2-1 may perform direct communication (e.g., P2P communication, D2D communication) with the STA 1-1 on the first link. When the direct communication between the STA 1-1 and the STA 2-1 is completed (e.g., teardown or stop), the STA MLD 2 and the AP MLD 1 may exchange an EML OMN frame indicating to resume the EMLSR operation (e.g., an EMLSR mode of an EML control field of the EML OMN frame is set to 1, or it may be a frame including an EMLSR/EMLMR link bitmap indicating links to be used in the EMLSR operation). When the EMLSR operation is resumed, the STA MLD 2 may perform the EMLSR operation on the first link and/or the second link. In other words, the STA MLD 2 may not perform the EMLSR operation while direct communication is performed, and the STA MLD 2 may resume the EMLSR operation after the direct communication is completed.

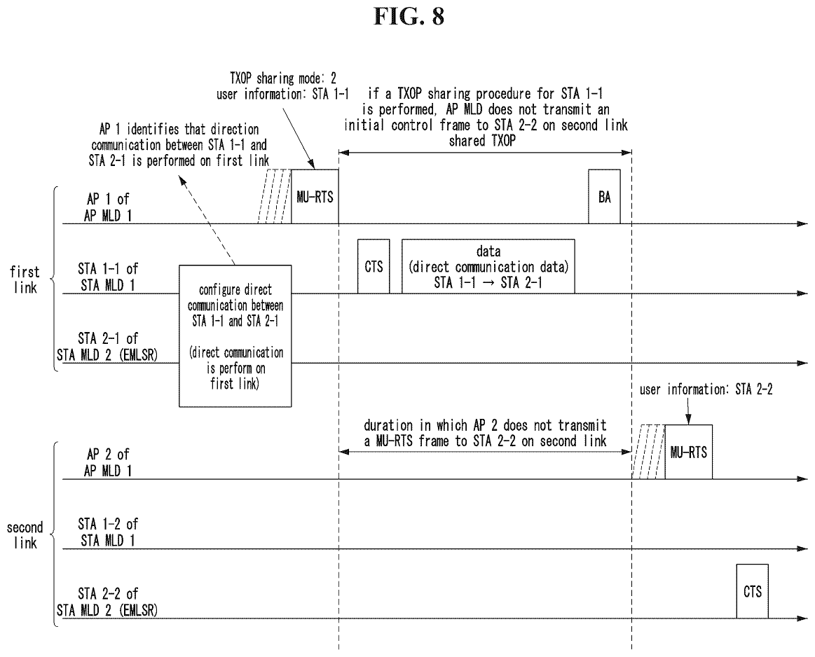

FIG. 8 is a timing diagram illustrating a fourth exemplary embodiment of a direct communication method in a wireless LAN.

Referring to FIG. 8, the wireless LAN may support multi-link operations. An AP MLD 1, STA MLD 1, and/or STA MLD 2 may operate on a multi-link (e.g., first link and second link). An AP affiliated with the AP MLD 1 operating on the first link may be referred to as an AP 1 (or AP 1-1). An AP affiliated with the AP MLD 1 operating on the second link may be referred to as an AP 2 (or AP 1-2). A STA affiliated with the STA MLD 1 operating on the first link may be referred to as a STA 1-1. A STA affiliated with the STA MLD 1 operating on the second link may be referred to as a STA 1-2. A STA affiliated with the STA MLD 2 operating on the first link may be referred to as a STA 2-1. A STA affiliated with the STA MLD 2 operating on the second link may be referred to as a STA 2-2. The STA MLD 2 may support enhanced an EMLSR operation (e.g., MLSR operation). In other words, the STA MLD 2 may be an EMLSR STA MLD (e.g., MLSR STA MLD).

The STA MLD 2 may perform the EMLSR operation on the first link and the second link. A procedure for configuring direct communication between the STA 1-1 (or another STA) and the STA 2-1 may be performed on the first link. In other words, a direct communication configuration may be set up on the first link. The direct communication configuration may be referred to as P2P configuration or D2D configuration. The direct communication configuration may be TDLS configuration. A frame including information element(s) (e.g., parameter(s), field(s)) or indicator(s) for direct communication configuration may be transmitted and received through the AP. In other words, the AP may relay transmission of the frame including information element(s) (e.g., parameter(s), field(s)) or indicator(s) for direct communication configuration between STAs.

Accordingly, the AP 1 (e.g., AP MLD with which the AP 1 is affiliated) may manage the STAs performing direct communication configuration, states of the STAs, and/or state of the direct communication configuration. The AP 1 (e.g., AP MLD with which the AP 1 is affiliated) may identify that the STA 1-1 and STA 2-1 have performed the direct communication configuration procedure, and manage a state of the direct communication relationship (e.g., direct communication configuration). A transmit opportunity (TXOP) sharing procedure may be triggered, and the AP 1 affiliated with the AP MLD 1 may perform the TXOP sharing procedure for the STA 1-1. In the TXOP sharing procedure, the AP 1 may transmit a MU-RTS frame (e.g., MU-RTS TXOP sharing (TXS) frame) including an information element or indicator (e.g., field, subfield) indicating a TXOP sharing mode 2 to the STA 1-1. The STA 1-1 may receive the MU-RTS frame from the AP 1 and identify information element(s) or indicator(s) included in the MU-RTS frame. The STA 1-1 may transmit a CTS frame to the AP 1 in response to the MU-RTS frame. The AP 1 may receive the CTS frame from the STA 1-1. A shared TXOP for the STA 1-1 may be configured by the above-described procedure. In other words, when the TXOP sharing procedure is completed, the shared TXOP may be configured.

The TXOP sharing procedure may be performed on the first link, and the AP MLD 1 may not transmit an initial control frame (e.g., MU-RTS frame, buffer status report poll (BSRP) trigger frame) to the STA 2-2 on the second link during the shared TXOP. During the shared TXOP, direct communication (e.g., P2P communication, D2D communication) between the STA 1-1 and STA 2-1 may be performed on the first link. In the present disclosure, the TXOP may mean a TXOP period and/or a time allocated by the TXOP sharing procedure. The STA 1-1 may not transmit an initial control frame (e.g., MU-RTS frame, BSRP trigger frame) to the STA 2-1. When a MU-RTS frame of the STA 1-1 is transmitted, a procedure for transmitting and receiving direct communication data (e.g., direct communication frame) between the STA 1-1 and STA 2-1 may be performed after the STA 2-1 transmits a CTS frame for the MU-RTS frame. Alternatively, a procedure for transmitting and receiving direct communication data (e.g., direct communication frame) between the STA 1-1 and STA 2-1 may be performed without transmission of a MU-RTS frame and/or CTS frame. When the shared TXOP is terminated (e.g., expired) or the shared TXOP is early terminated, the AP 2 affiliated with the AP MLD 1 may transmit an initial control frame (e.g., MU-RTS frame, BSRP trigger frame) to the STA 2-2. The STA 2-2 may receive the initial control frame from the AP 2.

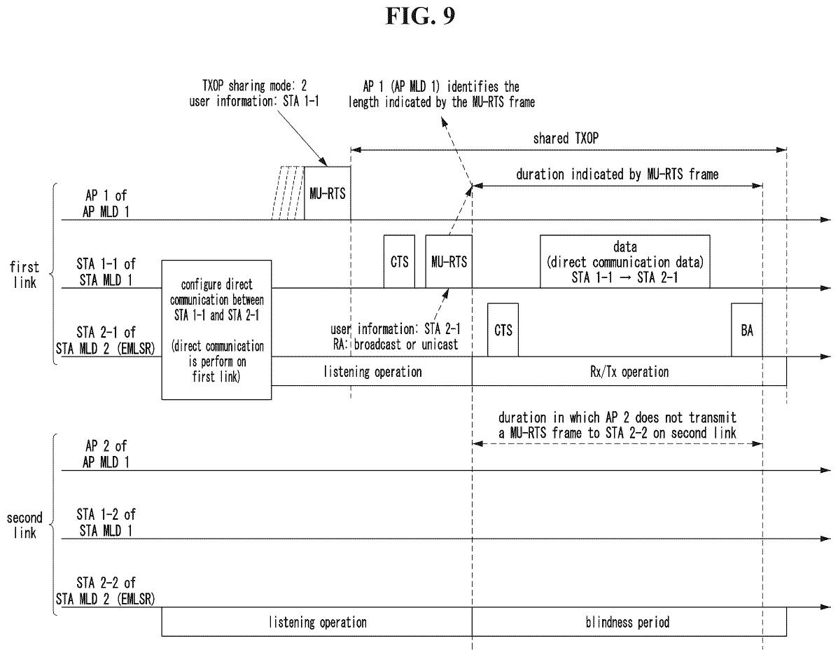

FIG. 9 is a timing diagram illustrating a fifth exemplary embodiment of a direct communication method in a wireless LAN.

Referring to FIG. 9, the wireless LAN may support multi-link operations. An AP MLD 1, STA MLD 1, and/or STA MLD 2 may operate on a multi-link (e.g., first link and second link). An AP affiliated with the AP MLD 1 operating on the first link may be referred to as an AP 1 (or AP 1-1). An AP affiliated with the AP MLD 1 operating on the second link may be referred to as an AP 2 (or AP 1-2). A STA affiliated with the STA MLD 1 operating on the first link may be referred to as a STA 1-1. A STA affiliated with the STA MLD 1 operating on the second link may be referred to as a STA 1-2. A STA affiliated with the STA MLD 2 operating on the first link may be referred to as a STA 2-1. A STA affiliated with the STA MLD 2 operating on the second link may be referred to as a STA 2-2. The STA MLD 2 may support enhanced an EMLSR operation (e.g., MLSR operation). In other words, the STA MLD 2 may be an EMLSR STA MLD (e.g., MLSR STA MLD).

The STA MLD 2 may perform the EMLSR operation on the first link and the second link. A procedure for configuring direct communication between the STA 1-1 (or another STA) and the STA 2-1 may be performed on the first link. In other words, a direct communication configuration may be set up on the first link. The direct communication configuration may be referred to as P2P configuration or D2D configuration. The direct communication configuration may be TDLS configuration. A frame including information element(s) (e.g., parameter(s), field(s)) or indicator(s) for direct communication configuration may be transmitted and received through the AP. In other words, the AP may relay transmission of the frame including information element(s) (e.g., parameter(s), field(s)) or indicator(s) for direct communication configuration between STAs.

Accordingly, the AP 1 (e.g., AP MLD with which the AP 1 is affiliated) may manage the STAs performing direct communication configuration, states of the STAs, and/or state of the direct communication configuration. The AP 1 (e.g., AP MLD with which the AP 1 is affiliated) may identify that the STA 1-1 and STA 2-1 have performed the direct communication configuration procedure, and manage a state of the direct communication relationship (e.g., direct communication configuration). A TXOP sharing procedure may be triggered, and the AP 1 affiliated with the AP MLD 1 may perform the TXOP sharing procedure for the STA 1-1. In the TXOP sharing procedure, the AP 1 may transmit a MU-RTS frame (e.g., MU-RTS TXOP TXS frame) including an information element or indicator (e.g., field, subfield) indicating a TXOP sharing mode 2 to the STA 1-1. The STA 1-1 may receive the MU-RTS frame from the AP 1 and identify information element(s) or indicator(s) included in the MU-RTS frame. The STA 1-1 may transmit a CTS frame to the AP 1 in response to the MU-RTS frame. The AP 1 may receive the CTS frame from the STA 1-1. A shared TXOP for the STA 1-1 may be configured by the above-described procedure. In other words, when the TXOP sharing procedure is completed, the shared TXOP may be configured.

The AP 1 affiliated with the AP MLD 1 may identify a frame transmitted by the STA 1-1 in the shared TXOP. The STA 1-1 may transmit an initial control frame (e.g., MU-RTS frame, BSRP trigger frame) to the STA 2-1 in the shared TXOP. In this case, the AP 1 may identify the MU-RTS frame transmitted by the STA 1-1. For example, the AP 1 may identify a duration field and/or user information field included in the MU-RTS frame of the STA 1-1. The AP MLD 1 may not transmit an initial control frame (e.g., MU-RTS frame, BSRP trigger frame) to the STA 2-2 on the second link during a time corresponding to the duration field included in the MU-RTS frame of the STA 1-1.

During the shared TXOP, direct communication (e.g., P2P communication, D2D communication) between the STA 1-1 and STA 2-1 may be performed on the first link. When the MU-RTS frame of the STA 1-1 is transmitted, a procedure for transmitting and receiving direct communication data (e.g., direct communication frame) between the STA 1-1 and STA 2-1 may be performed after the STA 2-1 transmits the CTS frame for the MU-RTS frame. The direct communication between the STA 1-1 and STA 2-1 may be performed within a duration indicated by the MU-RTS frame of the STA 1-1 in the shared TXOP. Alternatively, a procedure for transmitting and receiving direct communication data (e.g., direct communication frame) between the STA 1-1 and STA 2-1 may be performed without transmission of the MU-RTS frame and/or CTS frame. When the shared TXOP is terminated (e.g., expired) or the shared TXOP is early terminated, the AP 2 affiliated with the AP MLD 1 may transmit an initial control frame (e.g., MU-RTS frame, BSRP trigger frame) to the STA 2-2. The STA 2-2 may receive the initial control frame from the AP 2. As another method, after a time indicated by the duration field included in the MU-RTS frame of the STA 1-1, the AP 2 affiliated with the AP MLD 1 may transmit an initial control frame (e.g., MU-RTS frame, BSRP trigger frame) to the STA 2-2.

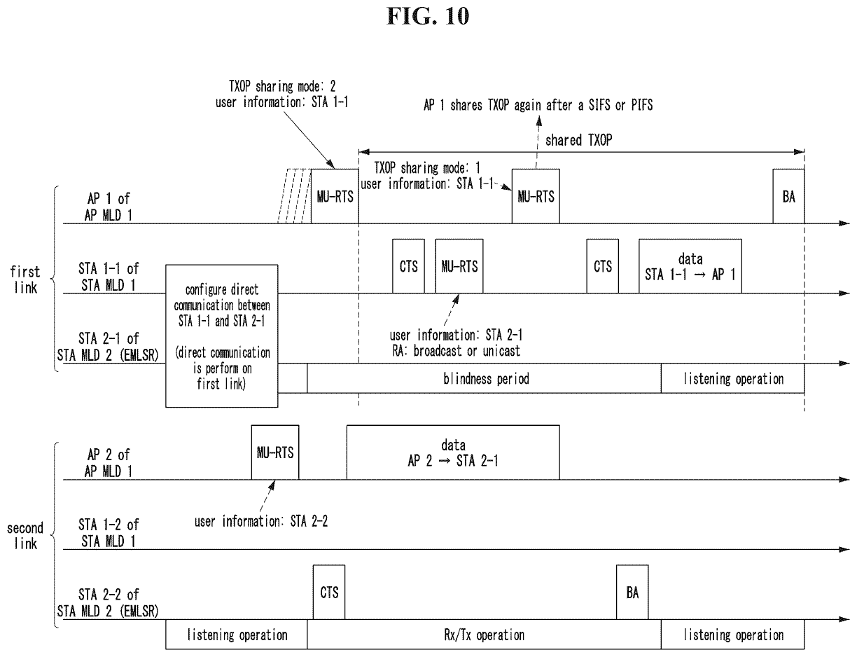

FIG. 10 is a timing diagram illustrating a sixth exemplary embodiment of a direct communication method in a wireless LAN.

Referring to FIG. 10, the wireless LAN may support multi-link operations. An AP MLD 1, STA MLD 1, and/or STA MLD 2 may operate on a multi-link (e.g., first link and second link). An AP affiliated with the AP MLD 1 operating on the first link may be referred to as an AP 1 (or AP 1-1). An AP affiliated with the AP MLD 1 operating on the second link may be referred to as an AP 2 (or AP 1-2). A STA affiliated with the STA MLD 1 operating on the first link may be referred to as a STA 1-1. A STA affiliated with the STA MLD 1 operating on the second link may be referred to as a STA 1-2. A STA affiliated with the STA MLD 2 operating on the first link may be referred to as a STA 2-1. A STA affiliated with the STA MLD 2 operating on the second link may be referred to as a STA 2-2. The STA MLD 2 may support enhanced an EMLSR operation (e.g., MLSR operation). In other words, the STA MLD 2 may be an EMLSR STA MLD (e.g.,

### MLSR STA MLD).

The STA MLD 2 may perform the EMLSR operation on the first link and the second link. A procedure for configuring direct communication between the STA 1-1 (or another STA) and the STA 2-1 may be performed on the first link. In other words, a direct communication configuration may be set up on the first link. The direct communication configuration may be referred to as P2P configuration or D2D configuration. The direct communication configuration may be TDLS configuration. A frame including information element(s) (e.g., parameter(s), field(s)) or indicator(s) for direct communication configuration may be transmitted and received through the AP. In other words, the AP may relay transmission of the frame including information element(s) (e.g., parameter(s), field(s)) or indicator(s) for direct communication configuration between STAs.

Accordingly, the AP 1 (e.g., AP MLD with which the AP 1 is affiliated) may manage the STAs performing direct communication configuration, states of the STAs, and/or state of the direct communication configuration. The AP 1 (e.g., AP MLD with which the AP 1 is affiliated) may identify that the STA 1-1 and STA 2-1 have performed the direct communication configuration procedure, and manage a state of the direct communication relationship (e.g., direct communication configuration). The AP 2 affiliated with the AP MLD 1 may transmit an initial control frame (e.g., MU-RTS frame, BSRP trigger frame) to the STA 2-2 to transmit a frame (e.g., data frame) to the STA 2-2 on the second link. The STA 2-2 may receive the initial control frame from the AP 2.

While communication between the AP 2 and the STA 2-2 is performed, the AP 1 affiliated with the AP MLD 1 may perform a TXOP sharing procedure for the STA 1-1. The TXOP sharing procedure may be triggered. In the TXOP sharing procedure, the AP 1 may transmit a MU-RTS frame (e.g., MU-RTS TXS frame) including an information element or indicator indicating a TXOP sharing mode 2 to the STA 1-1. The STA 1-1 may receive the MU-RTS frame from the AP 1 and identify information element(s) or indicator(s) included in the MU-RTS frame. The STA 1-1 may transmit a CTS frame to the AP 1 in response to the MU-RTS frame. The AP 1 may receive the CTS frame from the STA 1-1. A shared TXOP for the STA 1-1 may be configured by the above-described procedure. In other words, when the TXOP sharing procedure is completed, the shared TXOP may be configured.

The AP 1 affiliated with the AP MLD 1 may identify a frame transmitted by the STA 1-1 in the shared TXOP. The STA 1-1 may transmit an initial control frame (e.g., MU-RTS frame, BSRP trigger frame) to the STA 2-1 in the shared TXOP. Since the STA 2-2 of the STA MLD 2 is performing communication on the second link, the STA 2-1 may not be able to receive the initial control frame. In this case, the AP 1 may identify the MU-RTS frame transmitted by the STA 1-1. For example, the AP 1 may identify a duration field and/or user information field included in the MU-RTS frame of the STA 1-1. The AP 1 (e.g., AP MLD 1) may identify that the STA MLD 2 is unable to perform communication on the first link based on the identified information. Therefore, the AP 1 affiliated with the AP MLD 1 may retransmit a MU-RTS frame (e.g., MU-RTS TXS frame) for TXOP sharing after a short interframe space (SIFS) or priority interframe space (PIFS) elapses from a reception time of the MU-RTS frame of the STA 1-1.

The MU-RTS frame retransmitted by the AP 1 may indicate a TXOP sharing mode 1. Direct communication may not be possible in the TXOP sharing mode 1. In other words, when the TXOP sharing mode 1 is set, a STA may perform only transmission to the AP within the shared TXOP. As another method, the MU-RTS frame retransmitted by the AP 1 may indicate a TXOP sharing mode 2 or 1, and a shared TXOP for STA(s) that have not performed direct communication configuration with the STA MLD 2 may be configured. As another method, the AP 1 may terminate the shared TXOP by transmitting a contention frame (CF)-end frame instead of retransmitting the MU-RTS frame. The CF-end frame may be used to indicate early termination of the shared TXOP. The STA 1-1 may receive the CF-end frame from the AP 1 and determine that the shared TXOP is terminated based on the CF-end frame. As another method, the AP 1 may perform the TXOP sharing operation again. Alternatively, the AP 1 may transmit downlink frame(s) in the TXOP without terminating the shared TXOP.

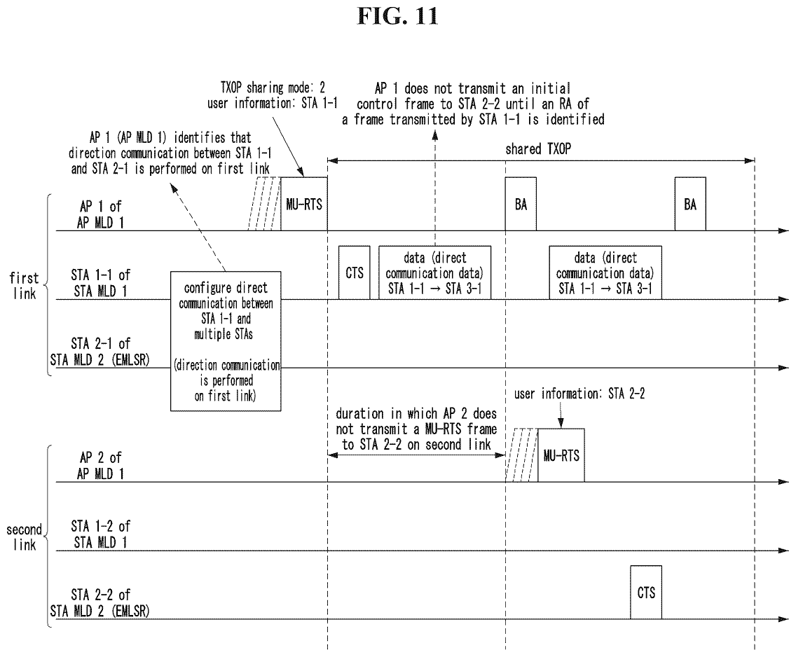

FIG. 11 is a timing diagram illustrating a seventh exemplary embodiment of a direct communication method in a wireless LAN.

Referring to FIG. 11, the wireless LAN may support multi-link operations. An AP MLD 1, STA MLD 1, and/or STA MLD 2 may operate on a multi-link (e.g., first link and second link). An AP affiliated with the AP MLD 1 operating on the first link may be referred to as an AP 1 (or AP 1-1). An AP affiliated with the AP MLD 1 operating on the second link may be referred to as an AP 2 (or AP 1-2). A STA affiliated with the STA MLD 1 operating on the first link may be referred to as a STA 1-1. A STA affiliated with the STA MLD 1 operating on the second link may be referred to as a STA 1-2. A STA affiliated with the STA MLD 2 operating on the first link may be referred to as a STA 2-1. A STA affiliated with the STA MLD 2 operating on the second link may be referred to as a STA 2-2. The STA MLD 2 may support enhanced an EMLSR operation (e.g., MLSR operation). In other words, the STA MLD 2 may be an EMLSR STA MLD (e.g., MLSR STA MLD).

The STA MLD 2 may perform the EMLSR operation on the first link and the second link. A procedure for configuring direct communication between the STA 1-1 (or another STA) and the STA 2-1 may be performed on the first link. In other words, a direct communication configuration may be set up on the first link. The direct communication configuration may be referred to as P2P configuration or D2D configuration. The direct communication configuration may be TDLS configuration. A frame including information element(s) (e.g., parameter(s), field(s)) or indicator(s) for direct communication configuration may be transmitted and received through the AP. In other words, the AP may relay transmission of the frame including information element(s) (e.g., parameter(s), field(s)) or indicator(s) for direct communication configuration between STAs.

Accordingly, the AP 1 (e.g., AP MLD with which the AP 1 is affiliated) may manage the STAs performing direct communication configuration, states of the STAs, and/or state of the direct communication configuration. The AP 1 (e.g., AP MLD with which the AP 1 is affiliated) may identify that the STA 1-1 and a plurality of STAs (e.g., a plurality of STAs including the STA 2-1) have performed the direct communication configuration procedure, and manage a state of the direct communication relationship (e.g., direct communication configuration). A TXOP sharing procedure may be triggered, and the AP 1 affiliated with the AP MLD 1 may perform the TXOP sharing procedure for the STA 1-1. In the TXOP sharing procedure, the AP 1 may transmit a MU-RTS frame (e.g., MU-RTS TXOP TXS frame) including an information element or indicator (e.g., field, subfield) indicating a TXOP sharing mode 2 to the STA 1-1. The STA 1-1 may receive the MU-RTS frame from the AP 1 and identify information element(s) or indicator(s) included in the MU-RTS frame. The STA 1-1 may transmit a CTS frame to the AP 1 in response to the MU-RTS frame. The AP 1 may receive the CTS frame from the STA 1-1. A shared TXOP for the STA 1-1 may be configured by the above-described procedure. In other words, when the TXOP sharing procedure is completed, the shared TXOP may be configured.

The AP 1 affiliated with the AP MLD 1 may identify a frame transmitted by the STA 1-1 in the shared TXOP. The STA 1-1 may transmit the frame (e.g., initial control frame, medium access control (MAC) protocol data unit (MPDU), aggregated (A)-MPDU, physical layer protocol data unit (PPDU)) to the STA 2-1 in the shared TXOP. The initial control frame may be a MU-RTS frame or a BSRP trigger frame. The AP 1 may identify a receiver address (RA) of the first MPDU transmitted by the STA 1-1 within the shared TXOP. The AP MLD 1 may not transmit an initial control frame (e.g., MU-RTS frame, BSRP trigger frame) to the STA 2-2 affiliated with the STA MLD 2 (e.g., EMLSR STA MLD 2) until the AP MLD 1 identifies the RA of the first MPDU transmitted by the STA 1-1 within the shared TXOP.

If it is identified that the RA of the first MPDU transmitted by the STA 1-1 does not indicate the STA 2-1, the AP 2 affiliated with the AP MLD 1 may transmit an initial control frame to the STA 2-2. The STA 2-2 may receive the initial control frame from the AP 2. If it is identified that the RA of the first MPDU transmitted by the STA 1-1 indicates the STA 2-1, the AP 2 affiliated with the AP MLD 1 may not transmit an initial control frame to the STA 2-2 until the shared TXOP is terminated on the first link.

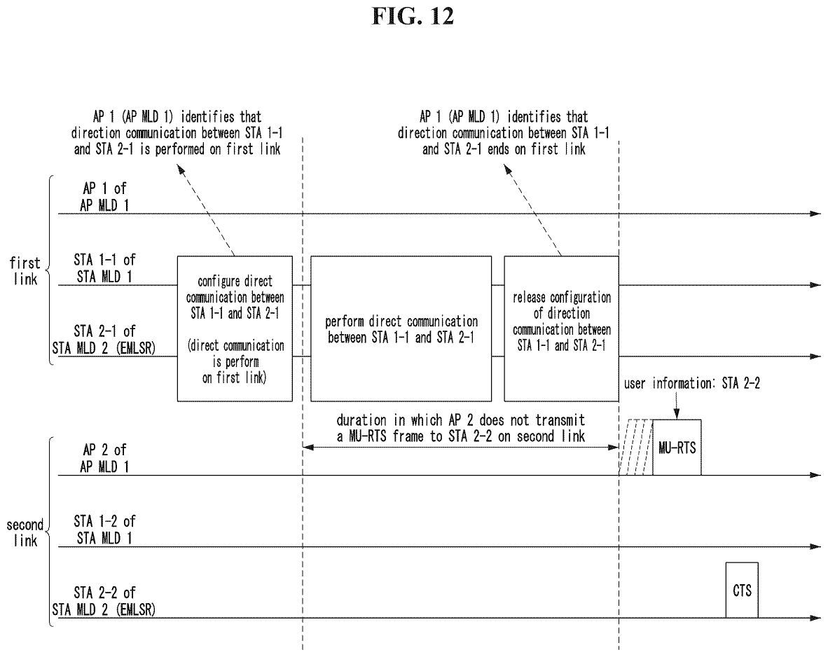

FIG. 12 is a timing diagram illustrating an eighth exemplary embodiment of a direct communication method in a wireless LAN.

Referring to FIG. 12, the wireless LAN may support multi-link operations. An AP MLD 1, STA MLD 1, and/or STA MLD 2 may operate on a multi-link (e.g., first link and second link). An AP affiliated with the AP MLD 1 operating on the first link may be referred to as an AP 1 (or AP 1-1). An AP affiliated with the AP MLD 1 operating on the second link may be referred to as an AP 2 (or AP 1-2). A STA affiliated with the STA MLD 1 operating on the first link may be referred to as a STA 1-1. A STA affiliated with the STA MLD 1 operating on the second link may be referred to as a STA 1-2. A STA affiliated with the STA MLD 2 operating on the first link may be referred to as a STA 2-1. A STA affiliated with the STA MLD 2 operating on the second link may be referred to as a STA 2-2. The STA MLD 2 may support enhanced an EMLSR operation (e.g., MLSR operation). In other words, the STA MLD 2 may be an EMLSR STA MLD (e.g., MLSR STA MLD).

The STA MLD 2 may perform the EMLSR operation on the first link and the second link. A procedure for configuring direct communication between the STA 1-1 (or another STA) and the STA 2-1 may be performed on the first link. In other words, a direct communication configuration may be set up on the first link. The direct communication configuration may be referred to as P2P configuration or D2D configuration. The direct communication configuration may be TDLS configuration. A frame including information element(s) (e.g., parameter(s), field(s)) or indicator(s) for direct communication configuration may be transmitted and received through the AP. In other words, the AP may relay transmission of the frame including information element(s) (e.g., parameter(s), field(s)) or indicator(s) for direct communication configuration between STAs.

Accordingly, the AP 1 (e.g., AP MLD with which the AP 1 is affiliated) may manage the STAs performing direct communication configuration, states of the STAs, and/or state of the direct communication configuration. The AP 1 (e.g., AP MLD with which the AP 1 is affiliated) may identify that the STA 1-1 and STA 2-1 have performed the direct communication configuration procedure, and manage a state of the direct communication relationship (e.g., direct communication configuration). When a direct communication configuration is set up, the AP MLD may consider that the EMLSR operation of the STA MLD 2 is implicitly stopped, and the STA MLD 2 uses only the first link. In other words, configuration of direct communication may implicitly indicate that the EMLSR operation of the STA MLD 2 is stopped. The AP MLD may consider that only the STA 2-1 affiliated with the STA MLD 2 operates.

When direct communication is configured, the STA MLD 2 may implicitly stop the EMLSR operation, and only the STA 2-1 affiliated with the STA MLD 2 may be used on the first link. For example, when direct communication is configured, the STA 2-1 may operate in a normal state, and the STA 2-2 may operate in a reception disabled state. In the normal state, the STS 2-1 may normally perform frame transmission and reception operations. In the reception disabled state, the STA 2-2 may not be able to receive frames.

The STA 2-1 may perform direct communication with the STA 1-1. When direct communication between the STA 1-1 and STA 2-1 is completed (e.g., teardown or stop), the STA 1-1 and STA 2-1 may perform a procedure for releasing direct communication configuration. In the procedure for releasing direct communication configuration, a frame including information element(s) or indicator(s) for releasing direct communication configuration may be transmitted to each STA through the AP 1. In other words, the AP 1 may relay transmission of the frame including information element(s) or indicator(s) for releasing direct communication configuration. The AP MLD 1 (e.g., AP 1) may identify the direct communication configuration between the STA 1-1 and STA 2-1 is released based on the frame including information element(s) or indicator(s) for releasing direct communication configuration. In this case, the AP MLD 1 may not manage the state of the direct communication relationship (e.g., direct communication configuration).

When the direct communication configuration is released, the AP MLD 1 may consider that the STA MLD 2 resumes the EMLSR operation. In other words, release of the direct communication configuration may imply resumption of the EMLSR operation. When the direct communication configuration is released, the STA MLD 2 may implicitly resume the EMLSR operation. As another method, when direct communication configuration is released, the STA MLD 2 may explicitly activate the EMLSR operation by exchanging with the AP MLD 1 an EML OMN frame including information element(s) or indicator(s) indicating activation of the EMLSR operation.

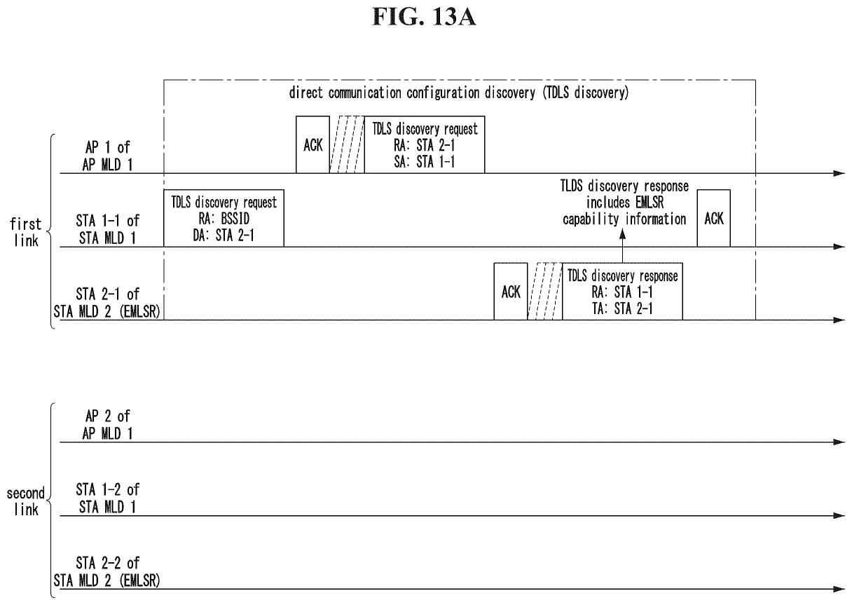

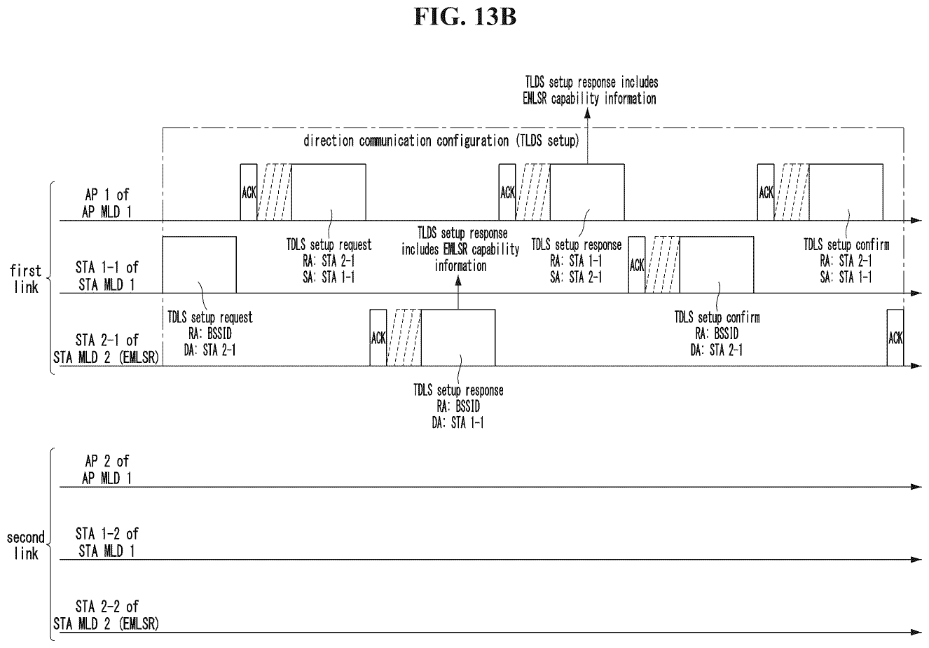

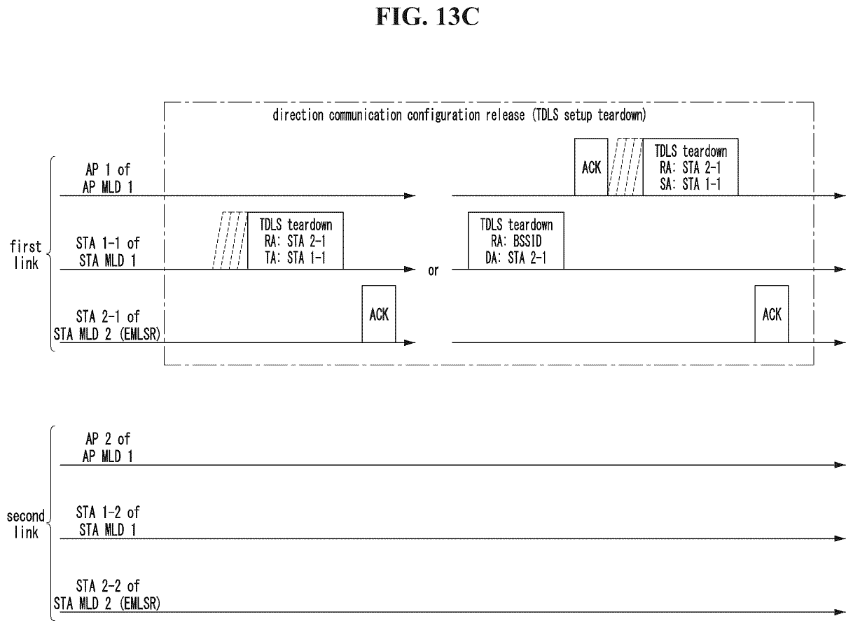

FIG. 13A is a timing diagram illustrating a first exemplary embodiment of a method for discovering direct communication configuration in a wireless LAN, FIG. 13B is a timing diagram illustrating a first exemplary embodiment of a method for configuring direct communication in a wireless LAN, and FIG. 13C is a timing diagram illustrating a first exemplary embodiment of a method for releasing direct communication configuration in a wireless LAN.

Referring to FIGS. 13A to 13C, the wireless LAN may support multi-link operations. An AP MLD 1, STA MLD 1, and/or STA MLD 2 may operate on a multi-link (e.g., first link and second link). An AP affiliated with the AP MLD 1 operating on the first link may be referred to as an AP 1 (or AP 1-1). An AP affiliated with the AP MLD 1 operating on the second link may be referred to as an AP 2 (or AP 1-2). A STA affiliated with the STA MLD 1 operating on the first link may be referred to as a STA 1-1. A STA affiliated with the STA MLD 1 operating on the second link may be referred to as a STA 1-2. A STA affiliated with the STA MLD 2 operating on the first link may be referred to as a STA 2-1. A STA affiliated with the STA MLD 2 operating on the second link may be referred to as a STA 2-2. The STA MLD 2 may support enhanced an EMLSR operation (e.g., MLSR operation). In other words, the STA MLD 2 may be an EMLSR STA MLD (e.g., MLSR STA MLD).

The STA MLD 2 may perform the EMLSR operation on the first link and the second link. A procedure for configuring direct communication between the STA 1-1 (or another STA) and the STA 2-1 may be performed on the first link. In other words, a direct communication configuration may be set up on the first link. The direct communication configuration may be referred to as P2P configuration or D2D configuration. The direct communication configuration may be TDLS configuration. A frame including information element(s) (e.g., parameter(s), field(s)) or indicator(s) for direct communication configuration may be transmitted and received through the AP. In other words, the AP may relay transmission of the frame including information element(s) (e.g., parameter(s), field(s)) or indicator(s) for direct communication configuration between STAs.

In the exemplary embodiment of FIG. 13A, in order to configure direct communication, a discovery procedure for direct communication (e.g., discovery procedure for direct communication configuration) may be performed. The discovery procedure for direct communication may be a TDLS discovery procedure. The discovery procedure for direct communication may be performed before a procedure for configuring direct communication. Direct communication between STAs discovered in the discovery procedure for direct communication may be configured. The STA 1-1 may be a TDLS initiator, and the STA 2-1 may be a TDLS responder. The STA 1-1 may transmit a TDLS discovery request frame to the AP 1. The TDLS discovery request frame may be referred to as a TDLS request frame. The TDLS discovery request frame may be a data frame. An RA field of the TDLS discovery request frame may be set to a basic service set identifier (BSSID). A destination address (DA) field of the TDLS discovery request frame may indicate the STA 2-1. The data frame (e.g., TDLS discovery request frame) may include capability information element(s) or indicator(s) for direct communication discovery.

The AP 1 may receive the TDLS discovery request frame from the STA 1-1, and deliver the TDLS discovery request frame to the STA 2-1, which is indicated by the DA of the TDLS discovery request frame. The STA 2-1 may receive the TDLS discovery request frame from the AP and identify information element(s) or indicator(s) included in the TDLS discovery request frame. The STA 2-1 may transmit a TDLS discovery response frame to the STA 1-1 in response to the TDLS discovery request frame. The TDLS discovery response frame may be referred to as a TDLS response frame. The TDLS discovery response frame may be a data frame. An RA field of the TDLS discovery response frame may indicate the STA 1-1. A transmitter address (TA) field of the TDLS discovery response frame may indicate the STA 2-1. The data frame (e.g., TDLS discovery response frame) may include capability information element(s) or indicator(s) for direct communication discovery.

Since the STA 2-1 performs the EMLSR operation, the TDLS discovery response frame may include EMLSR capability information element(s) or indicator(s) (e.g., information indicating whether to support the EMLSR operation, EMLSR operating link(s), etc.). Alternatively, the TDLS discovery response frame may be an action frame (e.g., public action frame), the RA field of the TDLS discovery response frame may indicate the STA 1-1, and the TA field of the TDLS discovery response frame may indicate the STA 2-1. As another method, a TDLS initiator may be the STA 2-1 and a TDLS responder may be the STA 1-1. In this case, the STA 2-1 may transmit a TDLS discovery request frame to the STA 1-1, and the STA 1-1 may transmit a TDLS discovery response frame to the STA 2-1 in response to the TDLS discovery request frame. The TDLS discovery request frame transmitted by the STA 2-1 may include EMLSR capability information element(s) or indicator(s) of the STA 2-1.

In the exemplary embodiment of FIG. 13B, a procedure for configuring direct communication may be performed. The procedure for configuring communication configuration may be a TDLS setup procedure. The STA 1-1 may be a TDLS initiator, and the STA 2-1 may be a TDLS responder. The STA 1-1 may transmit a TDLS setup request frame to the STA 2-1 through the AP. The STA 2-1 may receive the TDLS setup request frame of the STA 1-1 through the AP. The STA 2-1 may transmit a TDLS setup response frame to the STA 1-1 through the AP in response to the TDLS setup request frame. The STA 1-1 may receive the TDLS setup response frame of the STA 2-1 through the AP. The AP may relay transmission of the TDLS setup request/response frames between the STA 1-1 and STA 2-1.

The TDLS setup response frame of the STA 2-1 may include capability information element(s) or indicator(s) for direct communication configuration. Since the STA 2-1 performs the EMLSR operation, the TDLS setup response frame may include EMLSR capability information element(s) or indicator(s) (e.g., information indicating whether to support the EMLSR operation, EMLSR operating link(s), etc.). After receiving the TDLS setup response frame, the STA 1-1 may transmit a TDLS setup confirm frame to the STA 2-1 through the AP. The TDLS setup confirm frame may indicate completion of TDLS setup (e.g., completion of direct communication configuration). The STA 2-1 may receive the TDLS setup confirm frame of the STA 1-1 through the AP. When the transmission and reception procedure of the TDLS setup confirm frame is completed, direct communication between the STA 1-1 and STA 2-1 may be performed. Alternatively, the STA 2-1 may be a TDLS initiator and the STA 1-1 may be a TDLS responder. A TDLS setup request frame transmitted by the STA 2-1 may include EMLSR capability information element(s) or indicator(s).

In the exemplary embodiment of FIG. 13C, a procedure for releasing direct communication configuration may be performed. The procedure for releasing direct communication configuration may be performed in one of two methods. Alternatively, the procedure for releasing direct communication configuration may be performed by a combination of two methods. As a first method, the STA 1-1 may directly transmit a TDLS teardown frame to the STA 2-1. The TDLS teardown frame may request to release direct communication configuration. The STA 2-1 may receive the TDLS teardown frame from the STA 1-1. Alternatively, the STA 2-1 may directly transmit a TDLS teardown frame to the STA 1-1. The STA 1-1 may receive the TDLS teardown frame from the STA 2-1. As a second method, the STA 1-1 may transmit a TDLS teardown frame to the STA 2-1 through the AP. The STA 2-1 may receive the TDLS teardown frame of the STA 1-1 through the AP. Alternatively, the STA 2-1 may transmit a TDLS teardown frame to the STA 1-1 through the AP. The STA 1-1 may receive the TDLS teardown frame of the STA 2-1 through the AP.

As a third method, a combination of the first and second methods may be used. For example, the first method may be performed first, and then the second method may be performed. Alternatively, the second method may be performed first, and then the first method may be performed. According to the above-described methods, the direct communication configuration may be released. When the direct communication configuration between the STA 1-1 and STA 2-1 is released, the STA 1-1 and STA 2-1 may not perform direct communication.

The direct communication discovery procedure of FIG. 13A, the direct communication configuration procedure of FIG. 13B, and/or the direct communication configuration release procedure of FIG. 13C may be applied to the direct communication configuration operation and/or direct communication configuration response operation in the exemplary embodiments shown in FIGS. 5 to 12.

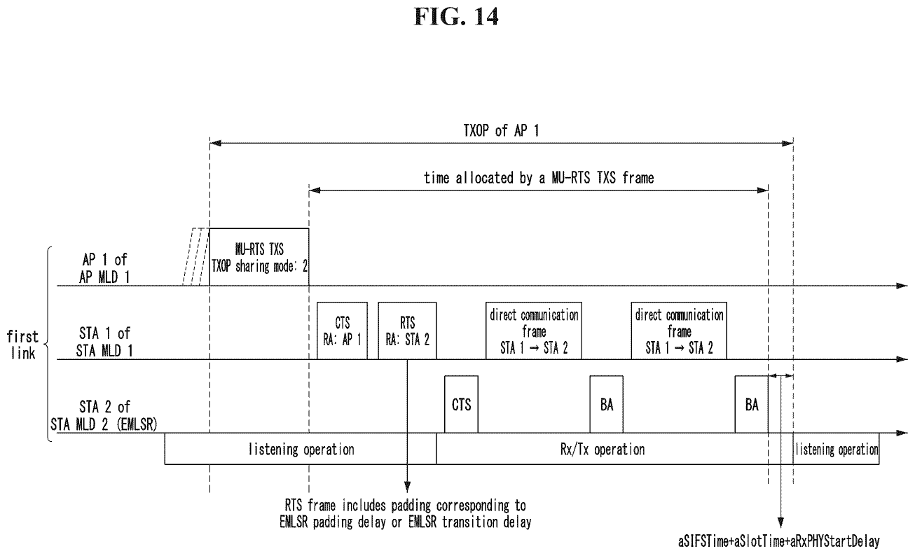

FIG. 14 is a timing diagram illustrating a ninth exemplary embodiment of a direct communication method in a wireless LAN.

Referring to FIG. 14, the wireless LAN may support multi-link operations. An AP MLD 1, STA MLD 1, and/or STA MLD 2 may operate on a multi-link (e.g., first link and second link). An AP affiliated with the AP MLD 1 operating on the first link may be referred to as an AP 1. A STA affiliated with the STA MLD 1 operating on the first link may be referred to as a STA 1. A STA affiliated with the STA MLD 2 operating on the first link may be referred to as a STA 2. The STA MLD 2 may perform an EMLSR operation (e.g., MLSR operation). In other words, the STA MLD 2 may be an EMLSR STA MLD (e.g., MLSR STA MLD).

In the EMLSR operation, the STA MLD 2 may perform a listening operation waiting for reception of an initial control frame on a multi-link, and when the initial control frame is received in the listening operation, the STA MLD 2 may perform frame transmission and reception operations on a link where the initial control frame is received. The initial control frame may be a MU-RTS frame and/or a BSRP frame (e.g., BSRP trigger frame). The STA MLD 2 may perform the EMLSR operation on EMLSR link(s). The EMLSR link(s) may include the first link. The STA 2 affiliated with the STA MLD 2 may perform the EMLSR operation. Therefore, the STA 2 may be referred to as an EMLSR STA.

The AP 1 may perform a channel access procedure on the first link. The channel access procedure may be an enhanced distributed channel access (EDCA) backoff procedure. The EDCA backoff procedure may be referred to as a backoff procedure or backoff operation. The AP 1 may succeed in the backoff procedure on the first link. When an EDCA backoff counter (e.g., backoff counter) reaches 0, the AP 1 may determine that the backoff procedure is successful. After the backoff procedure succeeds on the first link, the AP 1 may transmit a MU-RTS TXS frame on the first link. The MU-RTS TXS frame may be a MU-RTS trigger frame or a variant of the MU-RTS frame.

The AP 1 may acquire a TXOP on the first link. When the EDCA backoff counter of the AP 1 reaches 0 and an EDCA function (EDCAF) of the AP 1 decides to perform transmission, the AP 1 may acquire a TXOP. Alternatively, the AP 1 may acquire a TXOP by transmitting a frame. Alternatively, when the AP 1 transmits a frame and a response frame (e.g., ACK frame, BA frame, CTS frame) for the frame is received, the AP 1 may acquire a TXOP.

The AP 1 may indicate a shared TXOP using a MU-RTS TXS frame. The length of the shared TXOP may be set to a time allocated by the MU-RTS frame (e.g., MU-RTS TXS frame). The MU-RTS TXS frame may indicate a TXOP sharing mode 2. The MU-RTS TXS frame may indicate the length of the shared TXOP. The MU-RTS TXS frame may indicate a target sharing the TXOP. The target sharing the TXOP may be the STA 1. The STA 1 may receive the MU-RTS TXS frame (e.g., MU-RTS TXS trigger frame) from the AP 1 and transmit a CTS frame to the AP 1 in response to the MU-RTS TXS frame. The AP 1 may receive the CTS frame from the STA 1 in response to the MU-RTS TXS frame. A TA field of the CTS frame may be set to a MAC address of the STA 1. An RA field of the CTS frame may be set to a MAC address of the AP 1.

After transmitting the CTS frame, the STA 1 may transmit an RTS frame to the STA 2. The RTS frame may include a padding field (e.g., padding bit(s)), packet extension field, PHY padding, or the like corresponding to an EMLSR transition delay or EMLSR padding delay. The EMLSR transition delay or EMLSR padding delay may be set equal to a time required for the EMLSR STA MLD to change an operation of a radio chain (e.g., radio frequency (RF) chain). Alternatively, the EMLSR transition delay or EMLSR padding delay may be set to longer than the time required for the EMLSR STA MLD to change an operation of a radio chain (e.g., RF chain). At least one of the padding field, padding bit(s), packet extension field, or PHY padding may be added at the MAC layer and/or PHY layer. The padding field, padding bit(s), and/or packet extension field may be used to increase the length (e.g., transmission time) of the frame.

The padding field may be a MAC layer field of the trigger frame. Alternatively, the padding field may be a QoS Null frame included in a frame having an A-MPDU format. Repetition of an end of frame (EOF) delimiter in an A-MPDU may correspond to the padding bit(s). The packet extension field may be bit(s) or signal added to an end of the PPDU at the PHY layer. The PHY padding may be bit(s) or signal added to a start and/or end of the PPDU at the PHY layer. When the STA MLD 1 does not know the EMLSR transition delay or EMLSR padding delay of the STA MLD 2, the padding field, padding bit(s), and/or packet extension field corresponding to the EMLSR transition delay and/or EMLSR padding delay of the STA MLD 2 may be set to a preset value. The preset value may be 256 us.

A TA field of the RTS frame may be set to a MAC address of the STA 1. An RA field of the RTS frame may be set to a MAC address of the STA 2. The RTS frame may serve as an initial control frame. The initial control frame may be used to transition the operating state of the EMLSR device (e.g., EMLSR STA MLD, EMLSR STA) from the listening state to the normal state. In the listening state, the EMLSR device may perform a listening operation. The EMLSR device performing the listening operation may be able to receive only an initial control frame and frames with limited formats. In the normal state, the EMLSR device may normally perform frame transmission and reception operations. Instead of adding padding to the RTS frame, the same RTS frame may be transmitted twice with a SIFS or reduced interframe space (RIFS) time interval.

The STA 2, which is an EMLSR STA performing a listening operation, may receive the RTS frame from the STA 1. The STA 2 may operate in the normal state after receiving the RTS frame of the STA 1. The STA 2 may transmit a CTS frame to the STA 1 in response to the RTS frame. A TA field of the CTS frame may be set to a MAC address of the STA 2. An RA field of the CTS frame may be set to a MAC address of the STA 1. The STA 1 may receive the CTS frame from the STA 2. After receiving the CTS frame of the STA 2, the STA 1 may transmit a data frame to the STA 2. The data frame may be a direct communication frame (e.g., P2P frame, D2D frame). In other words, the data frame may be directly transmitted and received between the STAs without relaying by the AP.

Within the shared TXOP, the STA 1 may transmit a single frame or a plurality of frames to the STA 2. The STA 1 may no longer perform frame transmission to the STA 2. If a PHY-RXSTART.indication primitive does not occur during (aSIFSTime+aSlotTime+aRxPHYStartDelay) from a time when the STA 2 transmits the last response frame to the STA 1, the STA 2 may transition the operating state from the normal state to the listening state. An additional time may be required to transition from the normal state to the listening state. The additional time may be the EMLSR transition delay.

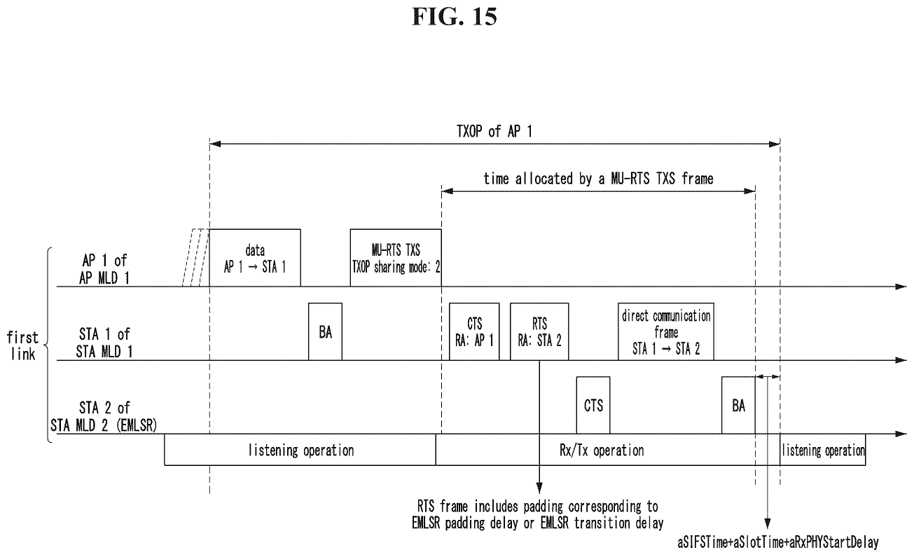

FIG. 15 is a timing diagram illustrating a tenth exemplary embodiment of a direct communication method in a wireless LAN.

Referring to FIG. 15, the wireless LAN may support multi-link operations. An AP MLD 1, STA MLD 1, and/or STA MLD 2 may operate on a multi-link (e.g., first link and second link). An AP affiliated with the AP MLD 1 operating on the first link may be referred to as an AP 1. A STA affiliated with the STA MLD 1 operating on the first link may be referred to as a STA 1. A STA affiliated with the STA MLD 2 operating on the first link may be referred to as a STA 2. The STA MLD 2 may perform an EMLSR operation (e.g., MLSR operation). In other words, the STA MLD 2 may be an EMLSR STA MLD (e.g., MLSR STA MLD).

In the EMLSR operation, the STA MLD 2 may perform a listening operation waiting for reception of an initial control frame on the multi-link, and when the initial control frame is received in the listening operation, the STA MLD 2 may perform frame transmission and reception operations on a link where the initial control frame is received. The initial control frame may be a MU-RTS frame and/or a BSRP frame (e.g., BSRP trigger frame). The STA MLD 2 may perform the EMLSR operation on EMLSR link(s). The EMLSR link(s) may include the first link. The STA 2 affiliated with the STA MLD 2 may perform the EMLSR operation. Therefore, the STA 2 may be referred to as an EMLSR STA.

The AP 1 may perform a channel access procedure on the first link. The channel access procedure may be an EDCA backoff procedure. The EDCA backoff procedure may be referred to as a backoff procedure or backoff operation. The AP 1 may succeed in the backoff procedure on the first link. When an EDCA backoff counter (e.g., backoff counter) reaches 0, the AP 1 may determine that the backoff procedure is successful. After the backoff procedure succeeds on the first link, the AP 1 may transmit a CTS-to-Self frame and an RTS frame frame on the first link.

The AP 1 may acquire a TXOP on the first link. In other words, the AP 1 may acquire a TXOP by transmitting the CTS-to-Self frame and RTS frame on the first link. When the EDCA backoff counter of the AP 1 reaches 0 and an EDCAF of the AP 1 decides to perform transmission, the AP 1 may acquire a TXOP. Alternatively, the AP 1 may acquire a TXOP by transmitting a frame. Alternatively, when the AP 1 transmits a frame and a response frame (e.g., ACK frame, BA frame, CTS frame) for the frame is received, the AP 1 may acquire a TXOP.

The AP 1 may transmit a MU-RTS TXS frame within the acquired TXOP of the first link. The MU-RTS TXS frame may be a MU-RTS trigger frame or a variant of the MU-RTS frame. The AP 1 may indicate a shared TXOP using the MU-RTS TXS frame. The length of the shared TXOP may be set to a time allocated by the MU-RTS frame (e.g., MU-RTS TXS frame). The MU-RTS TXS frame may indicate a TXOP sharing mode 2. The MU-RTS TXS frame may indicate the length of the shared TXOP. The MU-RTS TXS frame may indicate a target sharing the TXOP. The target sharing the TXOP may be the STA 1. The STA 1 may receive the MU-RTS TXS frame (e.g., MU-RTS TXS trigger frame) from the AP 1 and transmit a CTS frame to the AP 1 in response to the MU-RTS TXS frame. The AP 1 may receive the CTS frame from the STA 1 in response to the MU-RTS TXS frame. A TA field of the CTS frame may be set to a MAC address of the STA 1. An RA field of the CTS frame may be set to a MAC address of the AP 1.

After transmitting the CTS frame, the STA 1 may transmit an RTS frame to the STA 2. The RTS frame may include a padding field (e.g., padding bit(s)), packet extension field, PHY padding, or the like corresponding to an EMLSR transition delay or EMLSR padding delay. The EMLSR transition delay or EMLSR padding delay may be set equal to a time required for the EMLSR STA MLD to change an operation of a radio chain (e.g., RF chain). Alternatively, the EMLSR transition delay or EMLSR padding delay may be set to longer than the time required for the EMLSR STA MLD to change an operation of a radio chain (e.g., RF chain). At least one of the padding field, padding bit(s), packet extension field, or PHY padding may be added at the MAC layer and/or PHY layer. The padding field, padding bit(s), and/or packet extension field may be used to increase the length (e.g., transmission time) of the frame.

The padding field may be a MAC layer field of the trigger frame. Alternatively, the padding field may be a QoS Null frame included in a frame having an A-MPDU format. Repetition of an EOF delimiter in an A-MPDU may correspond to the padding bit(s). The packet extension field may be bit(s) or signal added to an end of the PPDU at the PHY layer. The PHY padding may be bit(s) or signal added to a start and/or end of the PPDU at the PHY layer. When the STA MLD 1 does not know the EMLSR transition delay or EMLSR padding delay of the STA MLD 2, the padding field, padding bit(s), and/or packet extension field corresponding to the EMLSR transition delay and/or EMLSR padding delay of the STA MLD 2 may be set to a preset value. The preset value may be 256us.

A TA field of the RTS frame may be set to a MAC address of the STA 1. An RA field of the RTS frame may be set to a MAC address of the STA 2. The RTS frame may serve as an initial control frame. The initial control frame may be used to transition the operating state of the EMLSR device (e.g., EMLSR STA MLD, EMLSR STA) from the listening state to the normal state. In the listening state, the EMLSR device may perform a listening operation. The EMLSR device performing the listening operation may be able to receive only an initial control frame and frames with limited formats. In the normal state, the EMLSR device may normally perform frame transmission and reception operations.

The STA 2, which is an EMLSR STA performing a listening operation, may receive an RTS frame from the STA 1. The STA 2 may operate in the normal state after receiving the RTS frame of the STA 1. The STA 2 may transmit a CTS frame to the STA 1 in response to the RTS frame. A TA field of the CTS frame may be set to a MAC address of the STA 2. An RA field of the CTS frame may be set to a MAC address of the STA 1. The STA 1 may receive the CTS frame from the STA 2. After receiving the CTS frame of the STA 2, the STA 1 may transmit a data frame to the STA 2. The data frame may be a direct communication frame (e.g., P2P frame, D2D frame). In other words, the data frame may be directly transmitted and received between the STAs without relaying by the AP.

Within the shared TXOP, the STA 1 may transmit a single frame or a plurality of frames to the STA 2. The STA 1 may no longer perform frame transmission to the STA 2. If a PHY-RXSTART.indication primitive does not occur during (aSIFSTime+aSlotTime+aRxPHYStartDelay) from a time when the STA 2 transmits the last response frame to the STA 1, the STA 2 may transition the operating state from the normal state to the listening state. An additional time may be required to transition from the normal state to the listening state. The additional time may be the EMLSR transition delay.

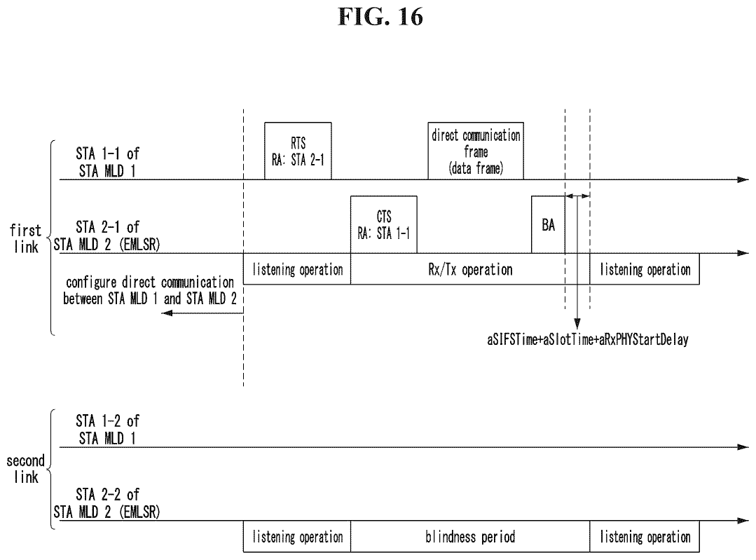

FIG. 16 is a timing diagram illustrating an eleventh exemplary embodiment of a direct communication method in a wireless LAN.

Referring to FIG. 16, the wireless LAN may support multi-link operations. An AP MLD 1, STA MLD 1, and/or STA MLD 2 may operate on a multi-link (e.g., first link and second link). An AP affiliated with the AP MLD 1 operating on the first link may be referred to as an AP 1 (or AP 1-1). An AP affiliated with the AP MLD 1 operating on the second link may be referred to as an AP 2 (or AP 1-2). A STA affiliated with the STA MLD 1 operating on the first link may be referred to as a STA 1-1. A STA affiliated with the STA MLD 1 operating on the second link may be referred to as a STA 1-2. A STA affiliated with the STA MLD 2 operating on the first link may be referred to as a STA 2-1. A STA affiliated with the STA MLD 2 operating on the second link may be referred to as a STA 2-2. The STA MLD 2 may support enhanced an EMLSR operation (e.g., MLSR operation). In other words, the STA MLD 2 may be an EMLSR STA MLD (e.g., MLSR STA MLD).

The STA MLD 1 and STA MLD 2 may perform direct communication configuration (e.g., P2P configuration, D2D configuration) on the multi-link. For example, the STA MLD 1 and STA MLD 2 may perform direct communication configuration on the first link and the second link, and may intend to perform direct communication. The direct communication configuration may include TDLS setup. The direct communication configuration may be performed on each of multiple links. For example, the STA 1-1 and STA 2-1 may perform direct communication configuration on the first link, and the STA 1-2 and STA 2-2 may perform direct communication configuration on the second link. Alternatively, direct communication configuration may be performed on the multi-link at once. For example, the STA MLD 1 and STA MLD 2 may perform direct communication configuration on the first link and the second link at once.

The STA MLD 2 may perform the EMLSR operation. In the EMLSR operation, the STA MLD 2 may perform a listening operation waiting for reception of an initial control frame on the multi-link, and when the initial control frame is received in the listening operation, the STA MLD 2 may perform frame transmission and reception operations on a link where the initial control frame is received. The STA MLD 2 may be referred to as EMLSR STA MLD, and each of the STA 2-1 and STA 2-2 may be referred to as EMLSR STA. The links on which the STA MLD 2 performs the EMLSR operation may be the first link and the second link. On the first link, STA MLD 1 may intend to transmit a direct communication frame (e.g., direct communication data) to the STA MLD 2.

The STA 1-1 affiliated with the STA MLD 1 may transmit an RTS frame to the STA 2-1 affiliated with the STA MLD 2. A TA field of the RTS frame may be set to a MAC address of the STA 1-1. An RA field of the RTS frame may be set to a MAC address of the STA 2-1. The RTS frame transmitted by the STA 1-1 may include a padding field (e.g., padding bit(s)), packet extension field, PHY padding, or the like corresponding to an EMLSR transition delay or EMLSR padding delay. The EMLSR transition delay or EMLSR padding delay may be set equal to a time required for the EMLSR STA MLD to change an operation of a radio chain (e.g., RF chain). Alternatively, the EMLSR transition delay or EMLSR padding delay may be set to longer than the time required for the EMLSR STA MLD to change an operation of a radio chain (e.g., RF chain). At least one of the padding field, padding bit(s), packet extension field, or PHY padding may be added at the MAC layer and/or PHY layer. The padding field, padding bit(s), and/or packet extension field may be used to increase the length (e.g., transmission time) of the frame.

The padding field may be a MAC layer field of the trigger frame. Alternatively, the padding field may be a QoS Null frame included in a frame having an A-MPDU format. Repetition of an end of frame (EOF) delimiter in an A-MPDU may correspond to the padding bit(s). The packet extension field may be bit(s) or signal added to an end of the PPDU at the PHY layer. The PHY padding may be bit(s) or signal added to a start and/or end of the PPDU at the PHY layer. When the STA MLD 1 does not know the EMLSR transition delay or EMLSR padding delay of the STA MLD 2, the padding field, padding bit(s), and/or packet extension field corresponding to the EMLSR transition delay and/or EMLSR padding delay of the STA MLD 2 may be set to a preset value. The preset value may be 256 us.

The RTS frame may serve as an initial control frame. The initial control frame may be used to transition the operating state of the EMLSR device (e.g., EMLSR STA MLD, EMLSR STA) from the listening state to the normal state. In the listening state, the EMLSR device may perform a listening operation. The EMLSR device performing the listening operation may be able to receive only an initial control frame and frames with limited formats. In the normal state, the EMLSR device may normally perform frame transmission and reception operations.

The STA 2-1, which is an EMLSR STA performing a listening operation, may receive the RTS frame from the STA 1-1. The STA 2-1 may operate in the normal state after receiving the RTS frame of the STA 1-1. The STA 2-1 may transmit a CTS frame to the STA 1-1 in response to the RTS frame. A TA field of the CTS frame may be set to a MAC address of the STA 2-1. An RA field of the CTS frame may be set to a MAC address of the STA 1-1. The STA 1-1 may receive the CTS frame from the STA 2-1. After receiving the CTS frame of the STA 2-1, the STA 1-1 may transmit a data frame to the STA 2-1. The data frame may be a direct communication frame (e.g., P2P frame, D2D frame). In other words, the data frame may be directly transmitted and received between the STAs without relaying by the AP.

The STA 1-1 may transmit a single frame or a plurality of frames to the STA 2-1. The STA 1-1 may no longer perform frame transmission to the STA 2-1. If a PHY-RXSTART.indication primitive does not occur during (aSIFSTime+aSlotTime+aRxPHYStartDelay) from a time when the STA 2-1 transmits the last response frame to the STA 1-1, the STA 2-1 may transition the operating state from the normal state to the listening state. An additional time may be required to transition from the normal state to the listening state. The additional time may be the EMLSR transition delay. While the STA MLD 2 (e.g., STA 2-1) performs frame transmission and reception operations on the first link, frame transmission and reception operations of the STA MLD 2 (e.g., STA 2-2) on the second link may be impossible.

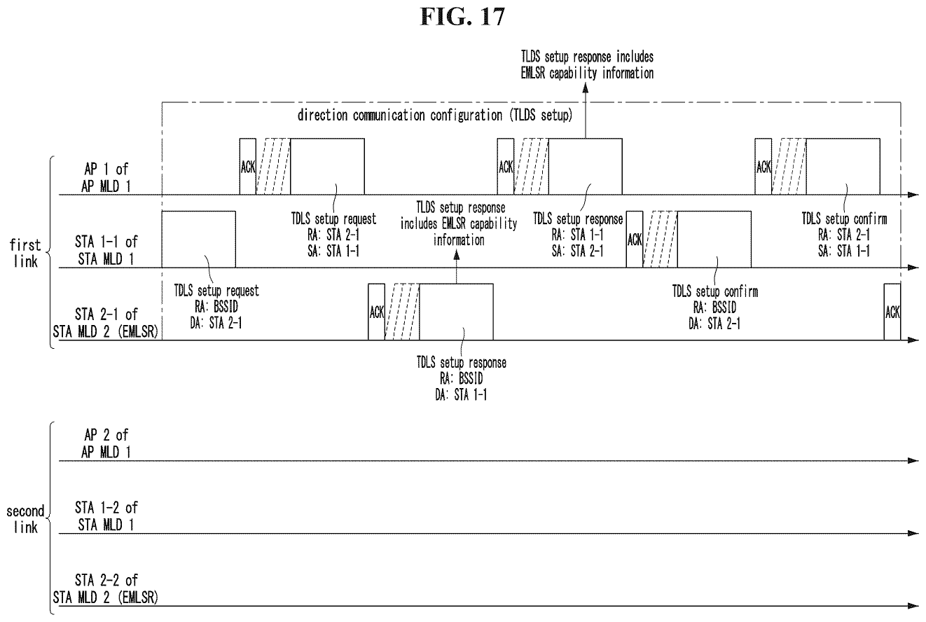

FIG. 17 is a timing diagram illustrating a twelfth exemplary embodiment of a direct communication method in a wireless LAN.

Referring to FIG. 17, a procedure for configuring direct communication may be performed. The procedure for configuring direct communication may be a TDLS procedure. The wireless LAN may support multi-link operations. An AP MLD 1, STA MLD 1, and/or STA MLD 2 may operate on a multi-link (e.g., first link and second link). An AP affiliated with the AP MLD 1 operating on the first link may be referred to as an AP 1 (or AP 1-1). An AP affiliated with the AP MLD 1 operating on the second link may be referred to as an AP 2 (or AP 1-2). A STA affiliated with the STA MLD 1 operating on the first link may be referred to as a STA 1-1. A STA affiliated with the STA MLD 1 operating on the second link may be referred to as a STA 1-2. A STA affiliated with the STA MLD 2 operating on the first link may be referred to as a STA 2-1. A STA affiliated with the STA MLD 2 operating on the second link may be referred to as a STA 2-2. The STA MLD 2 may support enhanced an EMLSR operation (e.g., MLSR operation). In other words, the STA MLD 2 may be an EMLSR STA MLD (e.g., MLSR STA MLD). Each of the STA 2-1 and the STA 2-2 may be an EMLSR STA. The STA MLD 2 may perform the EMLSR operation on EMLSR link(s). The EMLSR link(s) may include the first link and the second link.

The STA MLD 2 may perform the EMLSR operation on the first link and the second link. In the EMLSR operation, the STA MLD 2 may perform a listening operation waiting for reception of an initial control frame on the multi-link, and when the initial control frame is received in the listening operation, the STA MLD 2 may perform frame transmission and reception operations on a link where the initial control frame is received.

The STA 1-1 may be a TDLS initiator, and the STA 2-1 may be a TDLS responder. The STA 1-1 may transmit a TDLS setup request frame to the STA 2-1 through the AP. The STA 2-1 may receive the TDLS setup request frame of the STA 1-1 through the AP. The STA 2-1 may transmit a TDLS setup response frame to the STA 1-1 through the AP in response to the TDLS setup request frame. The STA 1-1 may receive the TDLS setup response frame of the STA 2-1 through the AP. The AP may relay transmission of the TDLS setup request/response frames between the STA 1-1 and STA 2-1.

The TDLS setup response frame of the STA 2-1 may include capability information element(s) or indicator(s) for direct communication configuration. Since the STA 2-1 performs the EMLSR operation, the TDLS setup response frame may include EMLSR capability information element(s) or indicator(s) of the STA 2-1. The EMLSR capability information element(s) or indicator(s) may include information indicating whether the STA MLD and/or STA supports the EMLSR operation, EMLSR padding delay, EMLSR transition delay, and/or EMLSR operating link. The EMLSR capability information element(s) or indicator(s) may be included in form of an EML capability subfield of multi-link element(s).

After receiving the TDLS setup response frame, the STA 1-1 may transmit a TDLS setup confirm frame to the STA 2-1 through the AP. The STA 2-1 may receive the TDLS setup confirm frame of the STA 1-1 through the AP. When the transmission and reception procedure of the TDLS setup confirm frame is completed, direct communication between the STA 1-1 and STA 2-1 may be performed. Alternatively, the STA 2-1 may be a TDLS initiator and the STA 1-1 may be a TDLS responder. A TDLS setup request frame transmitted by the STA 2-1 may include EMLSR capability information element(s) or indicator(s). The EMLSR capability information element(s) or indicator(s) may be included in form of an EML capability subfield of multi-link element(s).

The STA MLD 1 and STA MLD 2 in the exemplary embodiment of FIG. 17 may each be the same as the STA MLD 1 and STA MLD 2 in the exemplary embodiment of FIGS. 14 to 16. In the exemplary embodiments of FIGS. 14 to 16, in order to determine the length of the padding field, padding bit(s), packet extension field, and/or PHY padding of the RTS frame transmitted by the STA MLD 1 to the STA MLD 2, the EMLSR capability information element(s) or indicator(s) of the STA MLD 2 exchanged in the TLDS procedure (e.g., direct communication configuration procedure) may be used.

The operations of the method according to the exemplary embodiment of the present disclosure can be implemented as a computer readable program or code in a computer readable recording medium. The computer readable recording medium may include all kinds of recording apparatus for storing data which can be read by a computer system. Furthermore, the computer readable recording medium may store and execute programs or codes which can be distributed in computer systems connected through a network and read through computers in a distributed manner.

The computer readable recording medium may include a hardware apparatus which is specifically configured to store and execute a program command, such as a ROM, RAM or flash memory. The program command may include not only machine language codes created by a compiler, but also high-level language codes which can be executed by a computer using an interpreter.

Although some aspects of the present disclosure have been described in the context of the apparatus, the aspects may indicate the corresponding descriptions according to the method, and the blocks or apparatus may correspond to the steps of the method or the features of the steps. Similarly, the aspects described in the context of the method may be expressed as the features of the corresponding blocks or items or the corresponding apparatus. Some or all of the steps of the method may be executed by (or using) a hardware apparatus such as a microprocessor, a programmable computer or an electronic circuit. In some embodiments, one or more of the most important steps of the method may be executed by such an apparatus.

In some exemplary embodiments, a programmable logic device such as a field-programmable gate array may be used to perform some or all of functions of the methods described herein. In some exemplary embodiments, the field-programmable gate array may be operated with a microprocessor to perform one of the methods described herein. In general, the methods are preferably performed by a certain hardware device.

The description of the disclosure is merely exemplary in nature and, thus, variations that do not depart from the substance of the disclosure are intended to be within the scope of the disclosure. Such variations are not to be regarded as a departure from the spirit and scope of the disclosure. Thus, it will be understood by those of ordinary skill in the art that various changes in form and details may be made without departing from the spirit and scope as defined by the following claims.

1. A method of a first station (STA), the method comprising:
performing a procedure for configuring direct communication with a second STA on a first link;
performing a procedure for stopping an enhanced multi-link single radio (EMLSR) operation of the first STA with an access point (AP); and
after the EMLSR operation is stopped, performing direct communication with the second STA on the first link.

2. The method of claim 1, wherein the performing of the procedure for configuring direct communication comprises:
receiving a tunneled direct link setup (TDLS) setup request frame of the second STA through the AP;
in response to the TDLS setup request frame, transmitting a TDLS setup response frame to the second STA through the AP; and
in response to the TDLS setup response frame, receiving a TDLS setup confirm frame of the second STA through the AP,
wherein the TDLS setup response frame includes EMLSR capability information element(s) of the first STA, and the TDLS setup confirm frame indicates completion of TDLS setup.

3. The method of claim 1, wherein the performing of the procedure for stopping the EMLS operation with the AP comprises:
transmitting, to the AP, a first enhanced multi-link (EML) operating mode notification (OMN) frame that the EMLSR operation is to be stopped; and
in response to the first EML OMN frame, receiving a second EML OMN frame from the AP indicating that the EMLSR operation is stopped.

4. The method of claim 3, wherein each of the first EML OMN frame and the second EML OMN frame includes at least one of information indicating that the EMLSR operation is to be stopped or information on a link that the first STA is to use.

5. The method of claim 1, further comprising: transmitting a TDLS teardown frame requesting to release configuration of the direct communication to the second STA or the AP, wherein when a transmission and reception procedure of the TDLS teardown frame is completed, the configuration of the direct communication is released.

6. The method of claim 1, further comprising: performing a discovery procedure for discovering direct communication configuration before performing the procedure for configuring the direct communication,
wherein the performing of the discovery procedure comprises:
receiving a TDLS discovery request frame of the second STA through the AP; and
in response to the TDLS discovery request frame, transmitting a TDLS discovery response frame to the second STA through the AP,
wherein the TDLS discovery response frame includes EMLSR capability information element(s) of the first STA, and the procedure for configuring the direct communication is performed between the first STA and the second STA discovered in the discovery procedure.

8. The method of claim 1, further comprising: when the direct communication between the first STA and the second STA is completed, resuming the EMLSR operation of the first STA.

1. The method of claim 1, wherein the first STA is affiliated with a first STA multi-link device (MLD) operating on multiple links including the first link, and the second STA is affiliated with a second STA MLD operating on the multiple links including the first link.

9. A method of a first station (STA), the method comprising:
performing a procedure for configuring direct communication with a second STA on a first link;
performing a transmit opportunity (TXOP) sharing procedure with an access point (AP); and
performing direct communication with the second STA within a TXOP shared by the TXOP sharing procedure.

10. The method of claim 9, wherein the performing of the procedure for configuring direct communication comprises:
transmitting a tunneled direct link setup (TDLS) setup request frame to the second STA through the AP;
in response to the TDLS setup request frame, receiving a TDLS setup response frame of the second STA through the AP; and
in response to the TDLS setup response frame, transmitting a TDLS setup confirm frame to the second STA through the AP,
wherein the TDLS setup response frame includes EMLSR capability information element(s) of the second STA, and the TDLS setup confirm frame indicates completion of TDLS setup.

11. The method of claim 9, wherein the performing of the TXOP sharing procedure comprises:
receiving a multi-user (MU)-request-to-send (RTS) frame indicating TXOP sharing from the AP; and
transmitting a clear-to-send (CTS) frame to the AP in response to the MU-RTS frame.

12. The method of claim 9, further comprising:
transmitting a MU-RTS frame to the second STA in the shared TXOP; and
receiving a CTS frame from the second STA in response to the MU-RTS frame,
wherein the direct communication is performed within a duration indicated by the MU-RTS frame in the shared TXOP.

13. The method of claim 9, further comprising: transmitting a TDLS teardown frame requesting to release configuration of the direct communication to the second STA or the AP,
wherein when a transmission and reception procedure of the TDLS teardown frame is completed, the configuration of the direct communication is released.

14. The method of claim 9, further comprising: performing a discovery procedure for discovering direct communication configuration before performing the procedure for configuring the direct communication,
wherein the performing of the discovery procedure comprises:
transmitting a TDLS discovery request frame through the AP; and
in response to the TDLS discovery request frame, receiving a TDLS discovery response frame of the second STA through the AP,
wherein the TDLS discovery response frame includes EMLSR capability information element(s) of the second STA, and the procedure for configuring the direct communication is performed between the first STA and the second STA discovered in the discovery procedure.

15. The method of claim 9, wherein the first STA is affiliated with a first STA multi-link device (MLD) operating on multiple links including the first link, and the second STA is affiliated with a second STA MLD operating on the multiple links including the first link.

16. A first station (STA) comprising at least one processor, wherein the at least one processor causes the first STA to perform:
performing a procedure for configuring direct communication with a second STA on a first link;
performing a procedure for stopping an enhanced multi-link single radio (EMLSR) operation of the first STA with an access point (AP); and
after the EMLSR operation is stopped, performing direct communication with the second STA on the first link.

17. The first STA of claim 16, wherein in the performing of the procedure for configuring direct communication, the at least one processor further causes the first STA to perform:
receiving a tunneled direct link setup (TDLS) setup request frame of the second STA through the AP;
in response to the TDLS setup request frame, transmitting a TDLS setup response frame to the second STA through the AP; and
in response to the TDLS setup response frame, receiving a TDLS setup confirm frame of the second STA through the AP,
wherein the TDLS setup response frame includes EMLSR capability information element(s) of the first STA, and the TDLS setup confirm frame indicates completion of TDLS setup.

18. The first STA of claim 16, wherein in the performing of the procedure for stopping the EMLS operation with the AP, the at least one processor further causes the first STA to perform:
transmitting, to the AP, a first enhanced multi-link (EML) operating mode notification (OMN) frame that the EMLSR operation is to be stopped; and
in response to the first EML OMN frame, receiving a second EML OMN frame from the AP indicating that the EMLSR operation is stopped.

19. The first STA of claim 16, wherein the at least one processor further causes the first STA to perform: transmitting a TDLS teardown frame requesting to release configuration of the direct communication to the second STA or the AP, wherein when a transmission and reception procedure of the TDLS teardown frame is completed, the configuration of the direct communication is released.

20. The first STA of claim 16, wherein the at least one processor further causes the first STA to perform: when the direct communication between the first STA and the second STA is completed, resuming the EMLSR operation of the first STA.
